(19) United States
(12) Patent Application Publication
(10) Pub. No.: US 2015/0266239 A1
(43) Pub. Date: Sep. 24, 2015

(54) APPARATUS FOR PRODUCING THREE-DIMENSIONAL STRUCTURE, METHOD OF PRODUCING THREE-DIMENSIONAL STRUCTURE, AND THREE-DIMENSIONAL STRUCTURE

(71) Applicant: SEIKO EPSON CORPORATION, Tokyo (JP)

(72) Inventors: Eiji OKAMOTO, Matsumoto (JP); Junichi GOTO, Matsumoto (JP)

(21) Appl. No.: 14/643,425

(22) Filed: Mar. 10, 2015

(30) Foreign Application Priority Data
Mar. 18, 2014 (JP) 2014-054507

(51) Int. Cl. B29C 67/00

(52) U.S. Cl. CPC B29C 67/0081; B29C 67/0085; B33Y 10/00

(57) ABSTRACT

Provided is an apparatus for producing a three-dimensional structure of the invention that produces a three-dimensional structure by laminating layers using a paste-like composition containing grains, the apparatus including a stage for which the composition is provided and on which the layers are formed; a first layer forming unit that supplies the composition to a forming area on the stage and forms a first layer; and a film thickness adjusting unit that adjusts the film thickness of the first layer and sets the adjusted first layer as a second layer.

### BACKGROUND

1. Technical Field

The present invention relates to an apparatus for producing a three-dimensional structure, a method of producing a three-dimensional structure, and a three-dimensional structure.

2. Related Art

A technique of forming a three-dimensional structure by forming material layers (unit layers) on a stage (forming table) using a composition (forming material) that contains powder (grains) and laminating them to each other is known (for example, see JP-A-2001-150556). In this technique, a three-dimensional structure is formed by repeatedly performing the following operation. First, a material layer is formed by thinly spreading powder to have a uniform thickness and a bonding portion is formed by selectively bonding powder to each other in only a desired portion of the material layer. As a result, a thin plate-like member (hereinafter, referred to as a “cross-sectional member”) is formed in the bonding portion in which powder is bonded to each other. Next, another material layer is thinly formed on the material layer and a bonding portion is formed by selectively bonding powder to each other in only a desired portion of the material layer. As a result, a new cross-sectional member is formed on a newly formed material layer. At this time, the newly formed cross-sectional member is bonded to the previously formed cross-sectional member. A three-dimensional structure can be formed by laminating thin plate-like cross-section members (bonding portions) with each other one by one by repeatedly performing such an operation.

However, in the related art, there is a problem in that precise control of the thickness of each layer is difficult and dimensional precision of a three-dimensional structure which is finally obtained is degraded.

### SUMMARY

An advantage of some aspects of the invention is to provide an apparatus for producing a three-dimensional structure capable of efficiently producing a three-dimensional structure with excellent dimensional precision, a method of producing a three-dimensional structure capable of efficiently producing a three-dimensional structure with excellent dimensional precision, and a three-dimensional structure with excellent dimensional precision.

The invention is realized in the following forms.

According to an aspect of the invention, there is provided an apparatus for producing a three-dimensional structure that produces a three-dimensional structure by laminating layers using a paste-like composition containing grains, the apparatus including: a stage for which the composition is provided and on which the layers are formed; a first layer forming unit that supplies the composition to a forming area on the stage and forms a first layer; and a film thickness adjusting unit that adjusts the film thickness of the first layer and sets the adjusted first layer as a second layer.

In this manner, it is possible to provide an apparatus for producing a three-dimensional structure capable of efficiently producing a three-dimensional structure with excellent dimensional precision.

In the aspect of the invention, it is preferable that the apparatus for producing a three-dimensional structure further includes a bonding unit that bonds the grains constituting the second layer and forms a bonding portion, in which the film thickness adjusting unit relatively moves with respect to the stage and the bonding unit forms the bonding portion.

In the apparatus for producing a three-dimensional structure according to the aspect of the invention, it is preferable that the film thickness adjusting unit does not relative move with respect to the bonding unit when the film thickness of the first layer is adjusted.

In this manner, it is possible to easily control the apparatus for producing a three-dimensional structure and make the productivity of the three-dimensional structure particularly excellent.

In the apparatus for producing a three-dimensional structure according to the aspect of the invention, it is preferable that the bonding unit includes a binding solution providing unit that provides a binder solution for the second layer.

In this manner, it is possible to easily and reliably make the mechanical strength of the three-dimensional structure excellent.

In the apparatus for producing a three-dimensional structure according to the aspect of the invention, it is preferable that the binding solution contains a UV curable resin and the bonding unit includes a UV irradiation unit in addition to the binding solution providing unit.

In this manner, it is possible to make the mechanical strength of the three-dimensional structure which is finally obtained particularly excellent. Further, it is advantageous from viewpoints of the production cost and the productivity of the three-dimensional structure.

In the apparatus for producing a three-dimensional structure according to the aspect of the invention, it is preferable that the binding solution providing unit relatively moves with respect to the stage and provides the binding solution and the UV irradiation unit relatively moves with respect to the stage along with the relative movement of the binding solution providing unit.

In this manner, it is possible to prevent the configuration of the apparatus for producing a three-dimensional structure from being complicated and make the productivity of the three-dimensional structure particularly excellent.

In the aspect of the invention, it is preferable that the apparatus for producing a three-dimensional structure further includes a maintenance unit that performs maintenance of the binding solution providing unit.

In this manner, it is possible to make the dimensional precision and the reliability of the three-dimensional structure particularly excellent.

In the aspect of the invention, it is preferable that the apparatus for producing a three-dimensional structure further includes a recovery unit that recovers the composition removed from the first layer by the film thickness adjusting unit and the maintenance unit performs maintenance of the binding solution providing unit when the recovery unit recovers the composition.

In this manner, it is possible to reliably prevent the excessive amount of composition from adversely affecting the production of the three-dimensional structure.

In the apparatus for producing a three-dimensional structure according to the aspect of the invention, it is preferable that the bonding unit and the stage are capable of performing height adjustment thereof independently from each other.

In this manner, it is possible to more suitably adjust the distance from the binding solution providing unit to the outer surface of the second layer for which the binding solution is provided and to more reliably make the reliability of the shape of the bonding portion to be formed particularly excellent.

In the apparatus for producing a three-dimensional structure according to the aspect of the invention, it is preferable that the film thickness adjusting unit and the stage are capable of performing height adjustment thereof independently from each other.

In this manner, it is possible to more reliably make the dimensional precision of the three-dimensional structure which is finally obtained particularly excellent.

In the apparatus for producing a three-dimensional structure of the invention according to the aspect of the invention, it is preferable that the film thickness adjusting unit adjusts the film thickness of the second layer to be smaller than the film thickness of the first layer.

In the aspect of the invention, it is preferable that the apparatus for producing a three-dimensional structure further includes a recovery unit that recovers the composition removed from the first layer by the film thickness adjusting unit.

In this manner, it is possible to reliably prevent the excessive amount of composition from adversely affecting the production of the three-dimensional structure.

In the apparatus for producing a three-dimensional structure according to the aspect of the invention, it is preferable that the first layer forming unit is a dispenser that directly supplies the composition to the forming area.

In this manner, it is possible to shorten the time required for forming the first layer and to improve the productivity of the three-dimensional structure.

In the apparatus for producing a three-dimensional structure according to the aspect of the invention, it is preferable to be configured such that the composition is supplied to the forming area by the first layer forming unit and then the film thickness of the area is adjusted by the film thickness adjusting unit after 10 milliseconds to 10 seconds have passed.

In this manner, it is possible to keep the balance between the productivity of the three-dimensional structure and the dimensional precision of the three-dimensional structure in a higher level.

In the apparatus for producing a three-dimensional structure according to the aspect of the invention, it is preferable that the first layer forming unit is configured so as to be movable independently from the film thickness adjusting unit.

In this manner, it is possible to make the productivity of the three-dimensional structure sufficiently excellent and to make the dimensional precision and the reliability of the three-dimensional structure particularly excellent.

In the apparatus for producing a three-dimensional structure according to the aspect of the invention, it is preferable that at least one of the first layer forming unit and the film thickness adjusting unit includes a vibration providing unit that provides vibration.

In this manner, it is possible to more reliably make the dimensional precision of the three-dimensional structure which is finally obtained particularly excellent.

According to another aspect of the invention, a method of producing a three-dimensional structure produces a three-dimensional structure using the apparatus for producing a three-dimensional structure of the invention.

In this manner, it is possible to provide a method of producing a three-dimensional structure capable of efficiently producing the three-dimensional structure with excellent dimensional precision.

According to still another aspect of the invention, a method of producing a three-dimensional structure includes forming a first layer by supplying a paste-like composition containing grains to a forming area on a stage; and adjusting the film thickness of the first layer by a film thickness adjusting unit and setting the adjusted first layer as a second layer.

In this manner, it is possible to provide a method of producing a three-dimensional structure capable of efficiently producing a three-dimensional structure with excellent dimensional precision.

In the aspect of the invention, it is preferable that the method of producing a three-dimensional structure further includes bonding the grains constituting the second layer and forming a bonding portion, a plurality of layers are laminated with one another by repeatedly performing a series of the bonding of the grains, and the adjusting of the film thickness and the bonding of the grains are performed in an interlocked manner by relatively moving the film thickness adjusting unit with respect to the stage and forming the boning unit using the bonding unit.

In the method of producing a three-dimensional structure according to the aspect of the invention, it is preferable that the adjusting of the film thickness is performed by adjusting the film thickness of the second layer to be smaller than the film thickness of the first layer.

In the method of producing a three-dimensional structure according to the aspect of the invention, it is preferable that providing of a binding solution containing a UV curable resin for the second layer and curing of the UV curable resin are performed in the bonding of the grains.

In this manner, it is possible to make the mechanical strength of the three-dimensional structure which is finally obtained particularly excellent.

According to still another aspect of the invention, a three-dimensional structure is produced using the apparatus for producing a three-dimensional structure of the invention.

In this manner, it is possible to provide a three-dimensional structure with excellent dimensional precision.

### BRIEF DESCRIPTION OF THE DRAWINGS

The invention will be described with reference to the accompanying drawings, wherein like numbers reference like elements.

FIG. 1 is a cross-sectional view schematically illustrating an apparatus for producing a three-dimensional structure according to a preferred embodiment of the invention.

FIGS. 2A to 2C are cross-sectional views schematically illustrating an operation of the apparatus for producing a three-dimensional structure illustrated in FIG. 1 according to a preferred embodiment and respective processes of a method of producing a three-dimensional structure according to the preferred embodiment of the invention.

FIGS. 3A to 3C are cross-sectional views schematically illustrating an operation of the apparatus for producing a three-dimensional structure illustrated in FIG. 1 according to a preferred embodiment and respective processes of a method of producing a three-dimensional structure according to the preferred embodiment of the invention.

FIGS. 4A and 4B are cross-sectional views schematically illustrating an operation of the apparatus for producing a three-dimensional structure illustrated in FIG. 1 according to a preferred embodiment and respective processes of a method of producing a three-dimensional structure according to the preferred embodiment of the invention.

FIG. 5 is a cross-sectional view schematically illustrating a state in a second layer (composition for a three-dimensional structure).

FIG. 6 is a cross-sectional view schematically illustrating a state in which grains are bonded to each other with a hydrophobic binder.

FIG. 7 is a cross-sectional view schematically illustrating a mode of another operation of an apparatus for producing a three-dimensional structure of the invention.

### DESCRIPTION OF EXEMPLARY EMBODIMENTS

Hereinafter, preferred embodiments of the invention will be described in detail with reference to the accompanying drawings.

### Apparatus for Producing Three-Dimensional Structure and Method of Producing Three-Dimensional Structure

First, a configuration and a simple operation of an apparatus for producing a three-dimensional structure of the invention will be described.

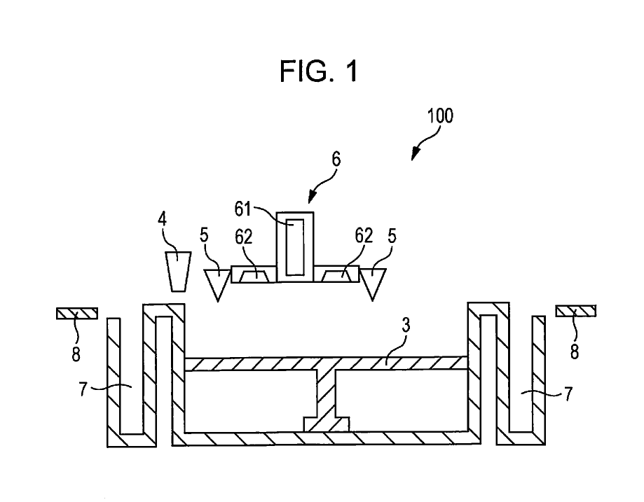

FIG. 1 is a cross-sectional view schematically illustrating an apparatus for producing a three-dimensional structure according to a preferred embodiment of the invention.

An apparatus 100 for producing a three-dimensional structure produces a three-dimensional structure 10 by laminating layers with each other using a paste-like composition (composition for three-dimensional forming) 11 containing grains 111.

As illustrated in FIG. 1, the apparatus 100 for producing a three-dimensional structure includes a control unit (not illustrated); a stage 3 for which the paste-like composition 11 containing the grains 111 is provided and on which a layer is formed; a first layer forming unit 4 that supplies the composition 11 to a forming area of the stage 3 and forms a first layer 1′; a film thickness adjusting unit 5 that adjusts the film thickness of the first layer 1′ formed by the first layer forming unit 4 and forms a second layer 1; and a bonding unit 6 that forms a bonding portion 13 on the second layer 1. The bonding unit 6 includes a binder solution providing unit 61 that ejects a binding solution 12 to the second layer 1 and a curing unit 62 that cures the binding solution 12. Further, the apparatus 100 for producing a three-dimensional structure includes a recovery unit 7 that recovers the composition 11 removed from the first layer 1′ by the film thickness adjusting unit 5 and a maintenance unit 8 that performs maintenance of the binding solution providing unit 61.

In addition, in the invention, a paste-like composition means that a composition contains a component in a liquid form at the time of forming a first layer and, for example, paste-like compositions includes a composition containing a solvent component and a composition containing a component which is in a solid form at room temperature and is melted by being heated at the time of forming the first layer.

In addition, in the invention, the forming area means an area capable of forming a layer and a bonding portion and, specifically, means an area overlapped with the stage when the apparatus for producing a three-dimensional structure is seen in a plan view.

A control unit (not illustrated) includes a computer and a drive control unit.

The computer is a general tabletop computer including a CPU or a memory in the inside thereof. The computer makes the shape of the three-dimensional structure 10 into data as model data and outputs cross-section data (slice data) obtained by slicing the data into a thin cross-section body formed of plural layers in parallel to the drive control unit.

The drive control unit functions as a control unit that drives each of the first layer forming unit 4, the stage 3, the film thickness adjusting unit 5, the binding solution providing unit 61, and the curing unit 62. Specifically, the drive control unit controls an ejecting pattern or an ejecting amount of the binding solution 12 using the binding solution providing unit 61; a supply amount of the composition 11 supplied from the first layer forming unit 4; the moving speed of the first layer forming unit 4; and a descent amount of the stage 3.

The stage 3 is a region for which the composition 11 is provided and on which layers (the first layer 1′ and the second layer 1) are formed.

The stage 3 has a flat surface (region for which the composition 11 is provided). In this manner, it is possible to easily and reliably form the first layer 1′ whose thickness is highly uniform.

It is preferable that the stage 3 is formed of a material with high strength. As the constituent material of the stage 3, for example, various metal materials such as stainless steel or the like can be exemplified.

In addition, the surface (region for which the composition 11 is provided) of the stage 3 may be subjected to a surface treatment. In this manner, it is possible to effectively prevent the constituent material of the composition 11 or the constituent material of the binding solution 12 from being adhered to the stage 3, to make the durability of the stage 3 particularly excellent, and to achieve stable production of the three-dimensional structure 10 for a longer period of time. As the material used in the surface treatment applied to the surface of the stage 3, for example, a fluorine resin such as polytetrafluoroethylene can be exemplified.

The stage 3 sequentially descends by a predetermined amount according to an instruction from the drive control unit when a new layer 1 is formed on the previously formed layer 1. The thickness of the layer 1 which is newly formed is prescribed by the descent amount or the like of the stage 3.

The first layer forming unit 4 forms the first layer 1′ by supplying the composition 11 to the forming area on the stage 3.

The first layer forming unit 4 is not particularly limited as long as the first layer forming unit is capable of supplying composition 11 and forming the first layer 1′, but a dispenser directly supplying the composition 11 to a forming area is preferable.

For example, the composition 11 can be moved to the forming area and form the first layer 1′ after the composition 11 is temporarily provided for a temporary placing portion other than the forming area, but the time required for forming the first layer 1′ can be shortened and the productivity of the three-dimensional structure 10 can be improved by directly supplying the composition 11 to the forming area using a dispenser (first layer forming unit 4). Further, since the first layer 1′ can be formed in a state in which the composition 11 reliably holds relatively high fluidity, it is possible to reliably prevent generation of defects on the first layer 1′ and the second layer 1 to be formed using the first layer 1′. As a result, it is possible to make the reliability of the three-dimensional structure 10 to be produced particularly excellent.

In the present embodiment, the first layer forming unit 4 moves in an X direction at predetermined speed according to an instruction from the drive control unit, supplies the composition 11 at predetermined speed, and forms the first layer 1′.

It is preferable that the dispenser has a longitudinal shape extending in a Y direction. In this manner, it is possible to more efficiently and more stably form the first layer 1′.

The film thickness adjusting unit 5 has a function of adjusting the film thickness of the first layer 1′ formed by the first layer forming unit 4 and forming the second layer 1 whose film thickness is smaller than the first layer 1′.

In this manner, it is possible to precisely control the thickness of the layer to be formed (second layer 1 on which the bonding portion 13 is to be formed) by temporarily forming the first layer 1′ using the first layer forming unit 4 and adjusting the film thickness using the film thickness adjusting unit 5. As a result, it is possible to make the dimensional precision of the three-dimensional structure 10 excellent.

The film thickness adjusting unit 5 is not particularly limited as long as the second layer 1 whose film thickness is adjusted can be formed, but a squeegee having a longitudinal shape extending the Y direction is preferable.

In this manner, it is possible to efficiently form the second layer 1 and to make the productivity of the three-dimensional structure 10 particularly excellent.

The squeegee includes a blade having a shape of a blade whose tip in the lower portion is pointed.

The length of the blade in the Y direction is greater than or equal to the width (length in the Y direction) of the forming area.

It is preferable that the film thickness adjusting unit 5 and the stage 3 are capable of performing height adjustment thereof independently from each other. That is, it is preferable that the three-dimensional structure 10 is configured such that the relative positional relationship between the film thickness adjusting unit 5 and the stage 3 is changed in the height direction at the time of producing the three-dimensional structure 10.

In this manner, since it is possible to suitably adjust the distance from the film thickness adjusting unit 5 to the first layer 1′ and to more reliably control the thickness of the second layer 1 to be formed, it is possible to more reliably make the dimensional precision of the three-dimensional structure 10 which is finally obtained particularly excellent.

The apparatus 100 for producing a three-dimensional structure may include a vibration providing unit (not illustrated) that provides vibration for at least one of the first layer forming unit 4 and the film thickness adjusting unit 5.

In this manner, since it is possible to further improve the uniformity of the thickness of the layers (the first layer 1′ and the second layer 1) to be formed, it is possible to more reliably and particularly improve the dimensional precision of the three-dimensional structure 10 which is finally obtained.

Further, since it is possible to suitably increase the fluidity of the composition 11 at the time of forming the first layer 1′ and adjusting the film thickness (at the time of forming the second layer 1), it is possible to form layers (the first layer 1′ and the second layer 1) whose thicknesses have sufficiently high uniformity even when the moving speed of the first layer forming unit 4 and the moving speed of the film thickness adjusting unit 5 are relatively high. Therefore, it is possible to make the productivity of the three-dimensional structure 10 particularly excellent.

The binding solution providing unit 61 provides the binding solution 12 for the layer 1.

When the three-dimensional structure 10 includes the binding solution providing unit 61, it is possible to easily and reliably make the mechanical structure of the three-dimensional structure 10 excellent.

Particularly, in the present embodiment, the binding solution providing unit 61 is a binding solution ejecting unit that ejects the binding solution 12 according to an ink jet method.

In this manner, it is possible to provide the binding solution 12 in a minute pattern and to produce the three-dimensional structure 10 with particularly excellent productivity even in a case of the three-dimensional structure 10 having a minute structure.

As a liquid droplet ejecting system (system of an ink jet method), a piezo system or a system of ejecting the binding solution 12 using bubbles generated by heating the binding solution 12 can be used, but a piezo system is preferable from a viewpoint of difficulty in changing the quality of a constituent component of the binding solution 12.

Moreover, it is preferable that the binding solution providing unit is a line head with plural ejecting holes arranged in the Y direction.

In this manner, it is possible to make the productivity of the three-dimensional structure 10 particularly excellent.

In the binding solution proving unit 61, the pattern to be formed in each layer 1 and the amount of the binding solution 12 provided for each unit of the layer 1 are controlled according to an instruction from the drive control unit. The ejecting pattern or the ejecting amount of the binding solution 12 with the binding solution providing unit 61 is determined based on the slice data.

Further, the bonding unit 6 is configured such that the film thickness adjusting unit 5 moves the forming area and forms the second layer 1 in an interlocked manner and forms the bonding portion 13. In this manner, it is possible to make the productivity of the three-dimensional structure 10 excellent. Further, since it is possible to effectively prevent generation of unintentional deformation or the like in the second layer 1 before the bonding portion 13 is formed, it is possible to make the dimensional precision and the reliability of the three-dimensional structure 10 particularly excellent.

Moreover, the interlocking between the film thickness adjusting unit 5 and the bonding unit 6 will be described below.

It is preferable that the binding solution providing unit 61 and the stage 3 are capable of performing height adjustment independently from each other. That is, it is preferable that the three-dimensional structure 10 is configured such that relative the positional relationship between the binding solution providing unit 61 and the stage 3 is changed in the height direction at the time of producing the three-dimensional structure 10.

In this manner, it is possible to more suitably adjust the distance from the binding solution providing unit 61 to the outer surface of the second layer 1 for which the binding solution 12 is provided and to more reliably make the reliability of the shape of the bonding portion 13 to be formed particularly excellent.

The curing unit 62 irradiates with energy rays for curing the binding solution 12 provided for the layer 1.

The kind of energy rays applied by the curing unit 62 varies according to the constituent material of the binding solution 12, and examples thereof include UV rays, visible light, infrared rays, X-rays, γ-rays, electron beams, and ion beams. Among these, it is preferable to use UV rays from a viewpoint of the cost and the productivity of the three-dimensional structure 10. In the description below, a case where the curing unit 62 is a UV ray irradiation unit that irradiates with UV rays will be mainly described.

The bonding unit 6 is provided with curing units 62 on both sides of the binding solution providing unit 61 in the X direction and the curing units 62 are fixedly provided with respect to the binding solution providing unit 61.

In this manner, it is possible to efficiently provide the binding solution 12 and to cure the binding solution 12 on both sides of the reciprocating bonding unit 6 in the X direction. As a result, it is possible to make the productivity of the three-dimensional structure 10 particularly excellent. In addition, it is possible to prevent the configuration of the apparatus 100 for producing a three-dimensional structure from being complicated when compared to a case where the binding solution providing unit 61 and the curing unit 62 are movably provided independently from each other.

The recovery unit 7 is a region that recovers the composition 11 removed from the first layer 1′ by the film thickness adjusting unit 5.

Since it is possible to prevent an excessive amount of composition 11 from being accumulated in the vicinity of the stage 3 or the like when such a recovery unit 7 is included, it is possible to more reliably prevent the excessive amount of composition 11 from adversely affecting production of the three-dimensional structure 10. Further, since the recovered composition 11 is used to produce the three-dimensional structure 10, it is possible to contribute to a decrease in production cost of the three-dimensional structure 10 and to save resources, which is preferable.

The maintenance unit 8 performs maintenance of the binding solution providing unit 61.

Since it is possible to more stably provide (eject) the binding solution 12 for a long period of time when such a maintenance unit 8 is included, it is possible to make the dimensional precision and the reliability of the three-dimensional structure 10 particularly preferable.

As the maintenance performed by the maintenance unit 8, wiping and wetting of the liquid droplet ejection surface of the binding solution providing unit 61 and suction of the ejecting unit of the binding solution providing unit 61 can be exemplified.

In the description above, the bonding portion (curing portion) is formed by the bonding unit including the binding solution providing unit and the curing unit in the apparatus for producing a three-dimensional structure, but the apparatus for producing a three-dimensional structure of the invention is not limited to an apparatus having such a configuration as a bonding unit and may include an energy ray irradiation unit that irradiates with energy rays for fusing (sintering and bonding) grains in place of the binding solution providing unit and the curing unit.

In a case where the apparatus for producing a three-dimensional structure includes an energy ray irradiation unit that irradiates energy rays for fusing (sintering and bonding) grains, the energy ray irradiation unit whose pattern to be formed in each second layer 1 (irradiation pattern of energy rays) and energy amount of energy rays to be applied to each portion of the second layers 1 are controlled according to an instruction from the drive control unit. The irradiation pattern, the energy amount, and the like of the energy rays applied by the energy ray irradiation unit are determined based on slice data.

Next, the specific operation of the apparatus for producing a three-dimensional structure of the invention and the method of producing a three-dimensional structure of the invention will be described.

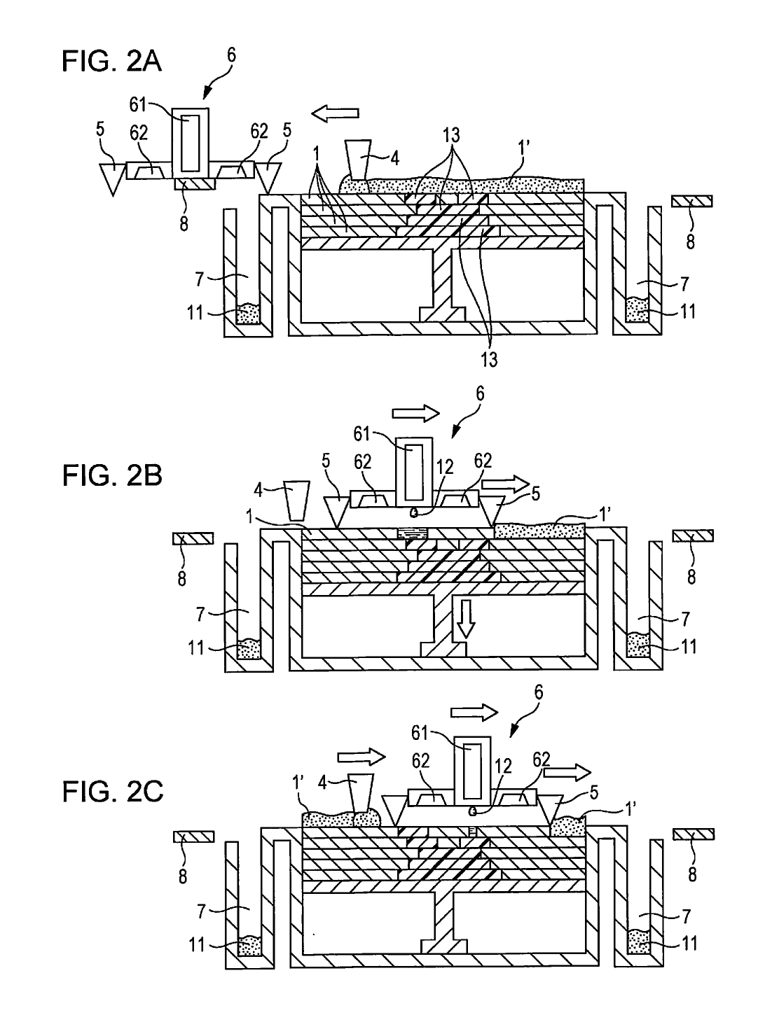

FIGS. 2A to 4B are cross-sectional views schematically illustrating an operation of the apparatus for producing a three-dimensional structure illustrated in FIG. 1 according to a preferred embodiment and respective processes of a method of producing a three-dimensional structure according to the preferred embodiment of the invention.

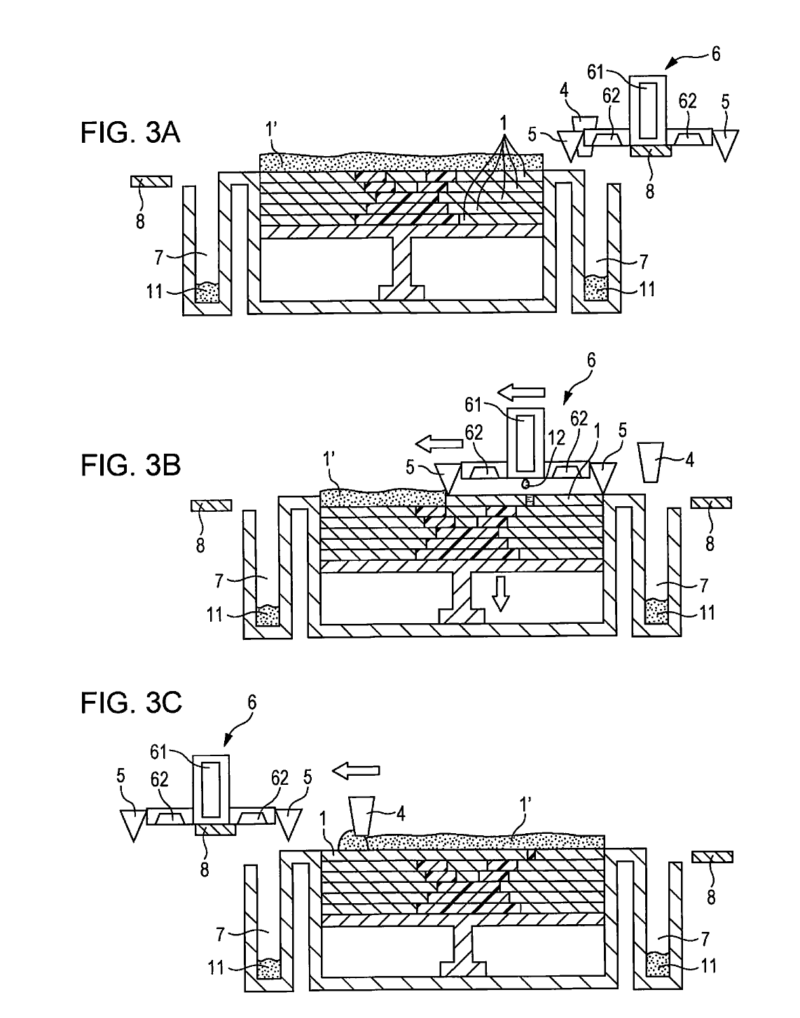

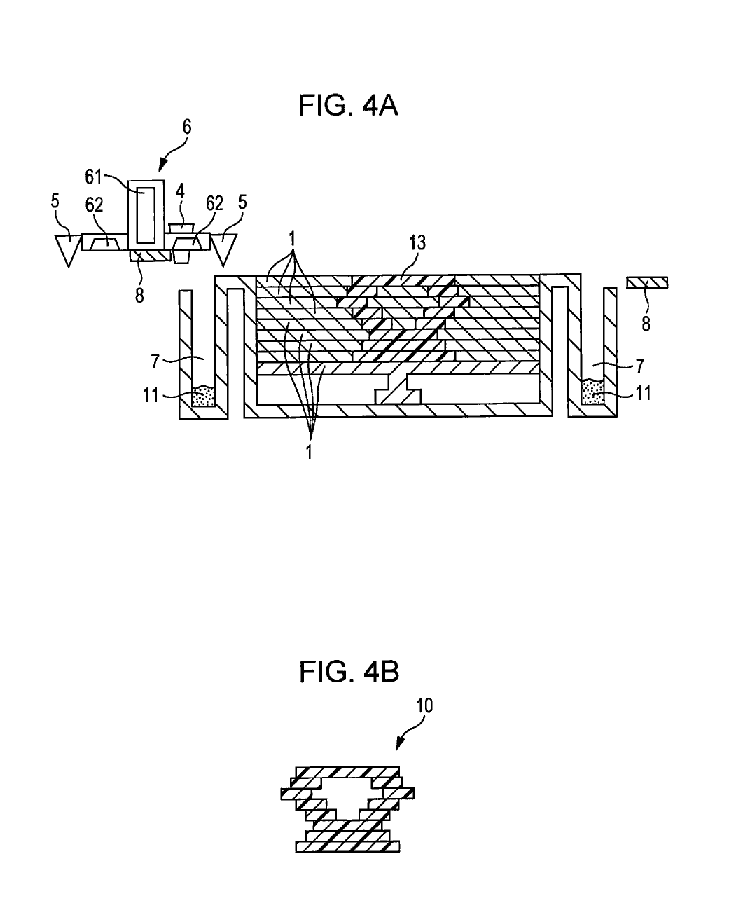

As illustrated in FIGS. 2A to 4B, the production method of the present embodiment includes a first layer forming process of supplying the paste-like composition 11 containing grains 111 to the forming area on the stage 3 and forming a first layer 1′ by the first layer forming unit 4 (see the left side portions of FIGS. 2A and 2C, and FIG. 3C); a film thickness adjusting process of adjusting the film thickness of the first layer 1′ and sets the adjusted first layer 1′ as a second layer 1 whose film thickness is smaller than the first layer 1′ by the film thickness adjusting unit 5 (see the vicinity of the center of FIG. 2B, the right side portion of FIG. 2C, and the vicinity of the center of FIG. 3B); a bonding process of performing a binding solution providing treatment of providing the binding solution 12 for the second layer 1 according to an ink jet method a curing treatment and a curing treatment of curing the binder 121 contained in the binding solution 12 provided for the second layer 1 (see the vicinity of the center of FIG. 2B, the vicinity of the center of FIG. 2C, and the right side portion of FIG. 3B); and an unbonded particle removing process of sequentially and repeatedly performing these processes and then removing unbonded particles from the grains 111 constituting each layer 1 with the binder 121 (see FIG. 4B).

Moreover, the film thickness adjusting process and the bonding process move the film thickness adjusting unit 5 in the forming area and form the bonding portion 13 using the bonding unit 6 in an interlocked manner (see FIGS. 2B, 2C, and 3B).

In this manner, the thickness of the layer (the second layer 1 on which the bonding portion 13 is to be formed) to be formed can be precisely controlled by forming the first layer 1′ and then adjusting the film thickness. As a result, it is possible to make the dimensional precision of the three-dimensional structure 10 excellent.

Further, when the film thickness adjusting process and the bonding process are performed in an interlocked manner, since it is possible to make the productivity of the three-dimensional structure 10 excellent and to effectively prevent generation of unintentional deformation in the second layer 1 before the bonding portion 13 is formed, it is possible to make the dimensional precision and the reliability of the three-dimensional structure 10 particularly excellent.

### First Layer Forming Process

In the first layer forming process, the paste-like composition 11 (composition for three-dimensional forming) containing the grains 111 is supplied to the forming area and the first layer 1′ is formed (see the left side portions of FIGS. 2A and 2C, and 3C).

It is possible to increase the fluidity of the composition 11 and to improve workability at the time of forming the first layer 1′ using a paste-like composition as the composition 11. Further, it is possible to prevent unintentional scattering of powder (grains 111) at the time of forming the first layer 1′.

In addition, the composition 11 will be described below.

In this process, the composition 11 is directly supplied to the forming area on the stage 3 using the first layer forming unit 4. That is, the composition 11 is supplied to the surface of the stage 3 by the first layer forming unit 4 in the first layer forming process performed for the first time and the composition 11 is supplied to the surface (upper surface) of the previously formed second layer 1 by the first layer forming unit 4 in the first layer forming process performed for the second or subsequent time.

In this manner, it is possible to shorten the time required for this process and to improve the productivity of the three-dimensional structure 10 by directly supplying the composition 11 to the forming area on the stage 3 using the first layer forming unit 4. In addition, since the first layer 1′ can be formed in a state in which the composition 11 reliably holds the relatively high fluidity, it is possible to reliably prevent generation of defects in the first layer 1′ and the second layer 1 to be formed using the first layer 1′. As a result, it is possible to make the reliability of the three-dimensional structure 10 to be produced particularly excellent.

In this process, the composition 11 may be heated. In this manner, for example, in the case where the composition 11 includes a melting component, it is possible to suitably make the composition 11 into a more paste-like composition.

The viscosity (value measured using an E-type viscometer (VISCONIC ELD, manufactured by Tokyo Keiki Co., Ltd.)) of the composition 11 in this process is preferably in the range of 7000 mPa·s to 60000 mPa·s and more preferably in the range of 10000 mPa·s to 50000 mPa·s.

In this manner, it is possible to make the working efficiency of this process particularly excellent.

The thickness of the first layer 1′ formed in this process is larger than that of the second layer 1 constituting the three-dimensional structure 10. In this manner, it is possible to reduce the shear stress at the time of layer formation using the paste-like composition 11 and to more reliably prevent generation of defects in a layer to be formed not by directly forming the second layer 1 having a target thickness but by temporarily forming the first layer 1′ whose thickness is larger than that of the second layer 1. Further, since a predetermined time has passed when the first layer 1′ is temporarily formed and then the second layer 1 is formed by removing a part of the first layer 1′ and the stability of the shape of the layer is improved, generation of defects in the second layer 1 to be formed is effectively prevented. For the reason of improvement of the stability in the shape, it is considered that at least some of a solvent is infiltrated into a lower layer side from a layer and the adhesiveness to the lower layer is improved until the second layer 1 is formed in a case where the composition 11 contains the solvent.

The thickness of the first layer 1′ formed in this process, which is not particularly limited, is preferably in the range of 50 μm to 800 μm and more preferably in the range of 80 μm to 300 μm.

In this manner, it is possible to make the productivity of the three-dimensional structure 10 sufficiently excellent and to make the dimensional precision of the three-dimensional structure 10 particularly excellent. In addition, it is possible to prevent an increase of the amount of the composition 11 to be removed in the film thickness removing process more than necessary.

Moreover, in a case where the first layer 1′ is uneven in thickness, it is preferable that the maximum thickness thereof is a value in the above-described range.

In addition, in the first layer 1′ to be formed in this process, the unevenness in thickness in each region may be relatively large. Further, the first layer 1′ may be formed as a layer in which the composition 11 is not provided for a part of the area on which the second layer 1 is to be formed. Even in such a case, the second layer 1 can be formed as a layer with sufficiently high uniformity in film thickness during the subsequent film thickness adjusting process.

Moreover, the thicknesses of the first layers 1′ formed during the first layer forming process performed plural times may be the same as or different from one another.

### Film Thickness Adjusting Process

In the film thickness adjusting process, the film thickness of the first layer 1′ is adjusted by the film thickness adjusting unit 5 (a part of the first layer 1′ is moved in the thickness direction) and the adjusted first layer 1′ is set as the second layer 1 (see the vicinity of the center of FIG. 2B, the right side portion of FIG. 2C, and the vicinity of the center of FIG. 3B).

As described above, since a predetermined time has passed when the first layer 1′ is temporarily formed and then the second layer 1 is formed by removing a part of the first layer 1′ and the stability of the shape of the layer is improved by the influence in which at least some of the solvent component which is a constituent component of the composition 11 is removed or the viscosity of a melting component which is a constituent component of the composition 11 is decreased (including solidification), the generation of defects in the second layer 1 to be formed in this process is effectively prevented.

Further, the shear rate (shear velocity) in this process becomes larger than the share rate during the first layer forming process for the reason described above.

It is preferable that the pressure applied to the first layer 1′ by the film thickness adjusting unit 5 during this process is larger than that applied by the first layer forming unit 4 during the first layer forming process described above.

The thickness of the second layer 1 to be formed during this process, which is not particularly limited, is preferably in the range of 30 μm to 500 μm and more preferably in the range of 70 μm to 150 μm, and it is desirable that the film thickness of the second layer 1 is adjusted to be smaller than that of the first layer 1′.

In this manner, it is possible to make the productivity of the three-dimensional structure 10 sufficiently excellent and to make the dimensional precision of the three-dimensional structure 10 particularly excellent.

Further, the thicknesses of the second layers 1 formed during the film thickness adjusting process performed plural times may be the same as or different from one another.

A difference (T1−T2) between a thickness T1 of the first layer 1′ and a thickness T2 of the second layer 1 is preferably in the range of 5 μm to 300 μm and more preferably in the range of 10 μm to 150 μm.

In this manner, it is possible to keep the balance between the productivity of the three-dimensional structure 10 and the dimensional precision of the three-dimensional structure 10 in a higher level.

In the configuration in the figure, the first layer forming unit 4 and the film thickness adjusting unit 5 move independently from each other. That is, it is preferable that the three-dimensional structure 10 is configured such that the relative positional relationship between the first layer forming unit 4 and the film thickness adjusting unit 5 is changed at the time of producing the three-dimensional structure 10.

In this manner, since the time to the film thickness adjusting process performed on the region after the first layer 1′ is formed can be suitably adjusted, the film thickness adjusting process can be performed in a state in which the stability of the shape of the first layer 1′ is sufficiently excellent. As a result, it is possible to make the productivity of the three-dimensional structure 10 sufficiently excellent and to make the dimensional precision and the reliability of the three-dimensional structure 10 particularly excellent.

Moreover, in the configuration in the figure, the film thickness adjusting unit 5 moves relatively to the bonding unit 6 when the film thickness of the first layer 1′ during this process is adjusted.

In this manner, it is possible to easily control the apparatus 100 for producing a three-dimensional structure and to make the productivity of the three-dimensional structure 10 particularly excellent.

Further, in a case where the bonding unit 6 is formed of plural members, it is preferable that the bonding unit does not move relatively to at least one member (particularly, as in the present embodiment, the binding solution providing unit 61 in a case of including the binding solution providing unit 61 and the curing unit 62). However, it is more preferable that the bonding unit 6 does not move relatively to plural members constituting the bonding unit 6 (particularly, as in the present embodiment, the binding solution providing unit 61 and the curing unit 62 in the case of including the binding solution providing unit 61 and the curing unit 62).

In this manner, in order to make the film thickness adjusting unit 5 not move relatively to the bonding unit 6 when the film thickness of the first layer 1′ during this process is adjusted, for example, the film thickness adjusting unit 5 may be fixed to the bonding unit 6 or the film thickness adjusting unit 5 and the bonding unit 6 may be moved in the interlocked manner even when the film thickness adjusting unit 5 is not fixed to the bonding unit 6, but it is preferable that the film thickness adjusting unit 5 is not fixed to the bonding unit 6.

In this manner, it is possible to more reliably obtain the above-described effects.

The time from when the composition 11 is supplied to the forming area by the first layer forming unit 4 to when the film thickness of the region is adjusted by the film thickness adjusting unit 5 is preferably in the range of 10 milliseconds to 10 seconds and more preferably in the range of 50 milliseconds to 5 seconds.

In this manner, it is possible to keep the balance between the productivity of the three-dimensional structure 10 and the dimensional precision of the three-dimensional structure 10 in a higher level. Further, since the adhesiveness of adjacent layers constituting the three-dimensional structure 10 becomes particularly excellent, it is possible to make the mechanical strength of the three-dimensional structure 10 particularly excellent.

In this process, the composition 11 removed from the first layer 1′ is recovered by the recovery unit 7.

Since the recovered composition 11 can be reused for production of the three-dimensional structure 10, this is preferable from a viewpoint of decreasing the production cost or saving resources of the three-dimensional structure 10.

The apparatus 100 for producing a three-dimensional structure includes a maintenance unit 8 and the maintenance of the binding solution providing unit 61 performed by the maintenance unit 8 may be performed at any timing, but it is preferable that the maintenance is performed when the composition 11 removed from the first layer 1′ is recovered by the recovery unit 7 during this process.

In this manner, it is possible to make the productivity of the three-dimensional structure 10 particularly excellent.

### Bonding Process

In the bonding process, the binding solution providing process of providing the binding solution 12 for the second layer 1 and the curing process of curing the binder 121 contained in the binding solution 12 provided for the second layer 1 are performed according to an ink jet method (see the vicinity of the center of FIG. 2B, the vicinity of the center of FIG. 2C, and the right side portion of FIG. 3B).

### Binding Solution Providing Process

The binding solution 12 bonds the grains 111 constituting the second layer 1.

The binding solution providing process is performed by selectively providing the binding solution 12 for only a region corresponding to an entity portion (region with an entity) of the three-dimensional structure 10 in the second layer 1.

In this manner, it is possible to finally form the bonding portion 13 having a desired shape by bonding the grains 111 constituting the second layer 1 each other. Moreover, it is possible to make the mechanical strength of the three-dimensional structure 10 which is finally obtained excellent.

In this process, since the binding solution 12 is provided according to an ink jet method, it is possible to provide the binding solution 12 with excellent reproducibility even when the providing pattern of the binding solution 12 has a minute shape. As a result, it is possible to particularly improve the dimensional precision of the three-dimensional structure 10 which is finally obtained.

Moreover, the binding solution 12 will be described below in detail.

### Curing Process

The curing process is performed by curing the binder 121 contained in the binding solution 12 provided for the second layer 1. In this manner, the bonding portion (curing portion) 13 is formed.

In this manner, it is possible to make the bonding strength between the binder 121 and the grains 111 particularly excellent by forming the bonding portion 13 as a curing portion and thus it is possible to make the mechanical strength of the three-dimensional structure 10 which is finally obtained particularly excellent.

This process varies depending on the kind of binder 121 used. For example, the process can be performed by heating in a case where the binder 121 is a thermosetting resin and the process can be performed by irradiation with corresponding light in a case where the binder 121 is a photocurable resin (for example, the process can be performed by irradiation with UV rays in a case where the binder 121 is a UV curable resin).

Particularly, in the binding solution providing process, it is preferable that the binding solution 12 containing a UV curable resin is provided for the second layer 1 and the UV curable resin contained in the binding solution 12 is cured in the curing process.

In this manner, it is possible to make the mechanical strength of the three-dimensional structure 10 which is finally obtained particularly excellent. Further, this is advantageous from viewpoints of the production cost and the productivity of the three-dimensional structure 10.

In the configuration in the figure, from this viewpoint, the binding solution providing unit 61 provides the binding solution 12 while relatively moving with respect to the stage 3 and the curing unit 62 relatively moves with respect to the stage 3 along with the relative movement of the binding solution providing unit 61.

In this manner, it is possible to prevent the configuration of the apparatus 100 for producing a three-dimensional structure from being complicated and make the productivity of the three-dimensional structure 10 particularly excellent.

In addition, the curing process can be omitted in a case where the binder 121 is not a curable component.

Further, as a post-treatment process, an unbonded particle removing process (see FIG. 4B) of removing unbonded particles from grains 111 constituting each second layer 1 which are not bonded together with the binder 121 is performed after a series of processes described above are repeatedly performed. In this manner, the three-dimensional structure 10 is extracted.

Specific examples of the method of this process include a method of brushing unbonded particles using a brush or the like; a method of removing unbonded particles through suction; a method of blowing gas such as air thereto; a method of providing a liquid such as water (for example, a method of immersing a laminate obtained in the above-described manner in a liquid or a method of blowing a liquid); and a method of providing vibration such as ultrasonic vibration thereto. Further, these methods can be used in a combination of two or more kinds thereof selected from these. More specifically, the method of immersing a laminate in a liquid such as water or a method of providing ultrasonic vibration in a state in which a laminate is immersed in a liquid such as water can be performed after gas such as air is blown thereto. Among these, it is preferable that a method of providing a liquid including water (particularly, a method of immersing a laminate in a liquid containing water) for a laminate obtained in the above-described manner is employed.

In the configuration of the figure, plural processes are concurrently performed. For example, in FIG. 2C, the film thickness adjusting process is performed in an area on the right side (most upstream side), the bonding process is performed in an area in the vicinity of the center, and the first layer forming process is performed in an area on the left side (most downstream side).

In this manner, by concurrently performing plural processes, it is possible to make reselection properties of the three-dimensional structure 10 particularly excellent.

Further, in the configuration of the figure, the film thickness adjusting process and the bonding portion forming process are performed on the n-th layer in the area on the upstream side and the first layer forming process is concurrently performed on the n+l-th layer in the area on the downstream side.

In this manner, it is possible to make the productivity of the three-dimensional structure 10 sufficiently excellent and to adjust the time from when the first layer forming process is performed to when the film thickness adjusting process is performed on an arbitrary layer to be relatively long. Accordingly, it is possible to more reliably make the stability of the shape of the first layer 1′ when the film thickness adjusting process is performed excellent. Therefore, by employing such a configuration, it is possible to make the productivity of the three-dimensional structure 10 sufficiently excellent and to reliably make the dimensional precision and the reliability of the three-dimensional structure 10 particularly excellent.

In the description above, the description is made that the bonding portion is formed using the binding solution. However, in the production method of the invention, the bonding portion may be formed using any method or the bonding portion may be formed by applying energy rays thereto and fusing (sintering and bonding) the grains 111.

According to the apparatus for producing a three-dimensional structure of the invention and the production method of the invention described above, it is possible to efficiently produce a three-dimensional structure with excellent dimensional precision.

### Composition (Composition for Three-Dimensional Forming)

Next, the composition used for producing a three-dimensional structure (composition for three-dimensional forming) 11 of the invention will be described in detail.

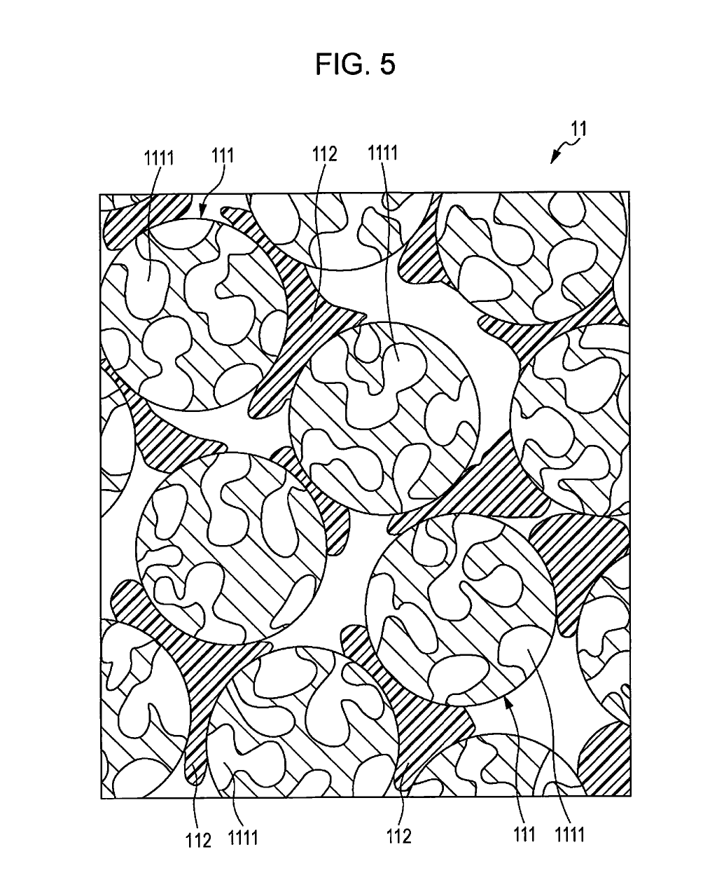

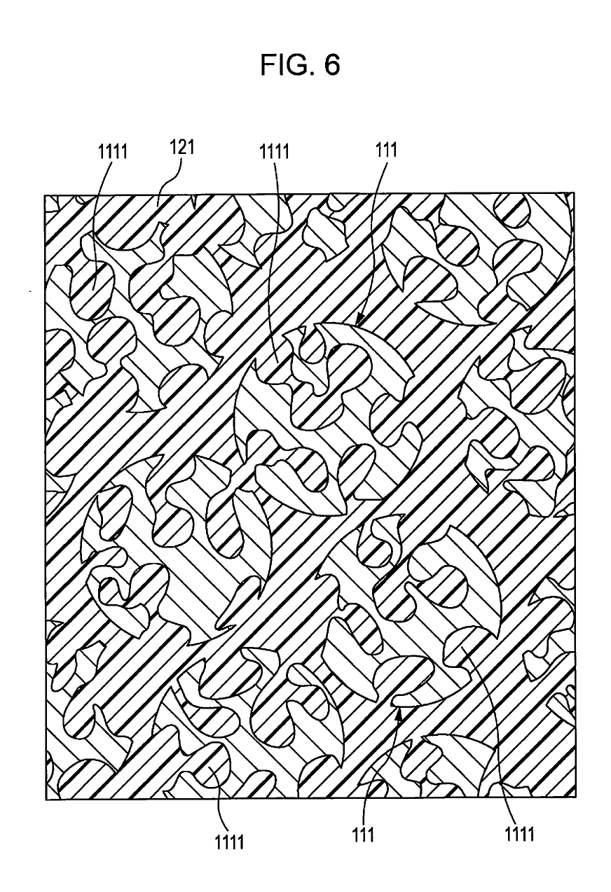

FIG. 5 is a cross-sectional view schematically illustrating a state in a second layer (composition for a three-dimensional structure). FIG. 6 is a cross-sectional view schematically illustrating a state in which grains are bonded to each other with a hydrophobic binder.

The composition (composition for three-dimensional forming) 11 includes at least powder for three-dimensional forming which contains plural grains 111 and has a shape of paste.

### Powder for Three-Dimensional Forming (Grains 111)

It is preferable that the grains 111 constituting powder for three-dimensional forming are porous and are subjected to a hydrophobic treatment. With such a configuration, in a case where a binding solution 12 includes a hydrophobic binder 121, it is possible for the hydrophobic binder 121 to suitably infiltrate into pores 1111 and thus an anchor effect is exhibited when the three-dimensional structure 10 is produced. As a result, it is possible to make the bonding force (bonding force through the binder 121) among the grains 111 excellent, and accordingly, it is possible to suitably produce the three-dimensional structure 10 with excellent mechanical strength (see FIG. 6). Further, such powder for three-dimensional forming can be suitably reused. More specifically, since a water-soluble resin 112 described below is prevented from entering the pores 1111 when the grains 111 constituting the powder for three-dimensional forming is subjected to a hydrophobic treatment, the grains 111 in an area for which the binding solution 12 is not provided in the production of the three-dimensional structure 10 can be recovered with a small content ratio of impurities and with high purity by washing the grains 111 with water or the like. Therefore, it is possible to reliably obtain the composition for three-dimensional forming controlled to have a desired composition by mixing the recovered powder for three-dimensional forming with the water-soluble resin 112 or the like again with a predetermined ratio. Further, it is possible to effectively prevent unintentional wet spreading of the binding solution 12 with the binder 121 constituting the binding solution 12 entering the pores 1111 of the grains 111. As a result, it is possible to further improve the dimensional precision of the three-dimensional structure 10 which is finally obtained.

Examples of the constituent material of the grains 111 constituting the powder for three-dimensional forming (mother particles to which a hydrophobic treatment is applied) include inorganic materials, organic materials, and complexes thereof.

Examples of the inorganic materials constituting the grains 111 include various metals or metal compounds. Examples of the metal compounds include various metal oxides such as silica, alumina, titanium oxide, zinc oxide, zirconium oxide, tin oxide, magnesium oxide, and potassium titanate; various metal hydroxides such as magnesium hydroxide, aluminum hydroxide, and calcium hydroxide; various metal nitrides such as silicon nitride, titanium nitride, and aluminum nitride; various metal carbides such as silicon carbide and titanium carbide; various metal sulfides such zinc sulfide; carbonate of various metals such as calcium carbonate and magnesium carbonate; sulfate of various metals such as calcium sulfate and magnesium sulfate; silicate of various metals such as calcium silicate and magnesium silicate; phosphate of various metals such as calcium phosphate; borate of various metals such as aluminum borate and magnesium borate; and complexes of these.

Examples of the organic materials constituting the grains 111 include a synthetic resin and a natural polymer. Further, specific examples thereof include a polyethylene resin; polypropylene; polyethylene oxide; polypropylene oxide; polyethylenimine; polystyrene; polyurethane; polyurea; polyester; a silicone resin; an acrylic silicone resin; a polymer using (meth)acrylic acid ester such as polymethylmethacrylate as a constituent monomer; a cross polymer (ethylene acrylic acid copolymer resin or the like) using (meth)acrylic acid ester such as a methyl methacrylate cross polymer as a constituent monomer; a polyamide resin such as Nylon 12, Nylon 6, or copolymer nylon; polyimide; carboxymethyl cellulose; gelatin; starch; chitin; and chitosan.

Among these, the grains 111 is formed of preferably an inorganic material, more preferably a metal oxide, and still more preferably silica. In this manner, it is possible to make properties such as the mechanical strength and light resistance of the three-dimensional structure 10 particularly excellent. Further, particularly, when the grains 111 are formed of silica, the above-described effects are better exhibited. Moreover, since silica has excellent fluidity, silica is advantageous for forming the second layer 1 having higher uniformity in thickness and also advantageous for making the productivity and the dimensional precision of the three-dimensional structure 10 particularly excellent.

As the hydrophobic treatment applied to the grains 111 constituting the powder for three-dimensional forming, any treatment can be performed as long as the treatment increases hydrophobicity of the grains 111 (mother particles), but a treatment of introducing a hydrocarbon group is preferable. In this manner, it is possible to increase the hydrophobicity of the grains 111. Further, it is possible to easily and reliably increase the uniformity of the hydrophobic treatment in each grain 111 or in each region of the surface of grains 111 (including the surface in the inside of the pores 1111).

As the compound used for the hydrophobic treatment, a silane compound including a silica group is preferable. Specific examples of the compound which can be used for the hydrophobic treatment include hexamethyl disilazane, dimethyl dimethoxy silane, diethyl diethoxy silane, 1-propenylmethyldichlorosilane, propyl dimethyl chlorosilane, propyl methyl dichlorosilane, propyl trichlorosilane, propyl triethoxy silane, propyl trimethoxy silane, styryl ethyl trimethoxysilane, tetradecyl trichlorosilane, 3-thiocyanate propyl triethoxysilane, p-tolyl dimethyl chlorosilane, p-tolyl methyl dichlorosilane, p-tolyl trichlorosilane, p-tolyl trimethoxysilane, p-tolyl triethoxysilane, di-n-propyldi-propoxysilane, diisopropyl diisopropoxysilane, di-n-butyldi-n-butyloxysilane, di-sec-butyldi-sec-butyloxysilane, di-t-butyldi-t-butyloxysilane, octadecyl trichlorosilane, octadecyl methyl diethoxysilane, octadecyl triethoxysilane, octadecyl trimethoxysilane, octadecyl dimethyl chlorosilane, octadecyl methyl dichlorosilane, octadecyl methoxy dichlorosilane, 7-octenyl dimethyl chlorosilane, 7-octenyl trichlorosilane, 7-octenyl trimethoxysilane, octyl methyl dichlorosilane, octyl dimethyl chlorosilane, octyl trichlorosilane, 10-undecenyl dimethyl chlorosilane, undecyl trichlorosilane, vinyl dimethyl chlorosilane, methyl octadecyl dimethoxysilane, methyl dodecyl diethoxysilane, methyl octadecyl dimethoxysilane, methyl octadecyl diethoxysilane, n-octyl methyl dimethoxysilane, n-octyl methyl diethoxysilane, triacontyl dimethyl chlorosilane, triacontyl trichlorosilane, methyl trimethoxysilane, methyl triethoxysilane, methyl tri-n-propoxysilane, methyl isopropoxysilane, methyl-n-butyloxysilane, methyl tri-sec-butyloxysilane, methyl tri-t-butyloxysilane, ethyl trimethoxysilane, ethyl triethoxysilane, ethyl tri-n-propoxysilane, ethyl isopropoxysilane, ethyl-n-butyloxysilane, ethyl tri-sec-butyloxysilane, ethyl tri-t-butyloxysilane, n-propyl trimethoxysilane, isobutyl trimethoxysilane, n-hexyl trimethoxysilane, hexadecyl trimethoxysilane, n-octyl trimethoxysilane, n-dodecyl trimethoxysilane, n-octadecyl trimethoxysilane, n-propyl triethoxysilane, isobutyl triethoxysilane, n-hexyl triethoxysilane, hexadecyl triethoxysilane, n-octyl triethoxysilane, n-dodecyl trimethoxysilane, n-octadecyl triethoxysilane, 2-[2-(trichlorosilyl)ethyl]pyridine, 4-[2-(trichlorosilyl)ethyl]pyridine, diphenyl dimethoxysilane, diphenyl diethoxysilane, 1,3-(trichlorosilylmethyl)hetacosane, dibenzyl dimethoxysilane, dibenzyl diethoxysilane, phenyl trimethoxysilane, phenyl methyl dimethoxysilane, phenyl dimethyl methoxysilane, phenyl dimethoxysilane, phenyl diethoxysilane, phenyl methyl diethoxysilane, phenyl dimethyl ethoxysilane, benzyl triethoxysilane, benzyl trimethoxysilane, benzyl methyl dimethoxysilane, benzyl dimethyl methoxysilane, benzyl dimethoxysilane, benzyl dimethyl ethoxysilane, benzyl methyl diethoxysilane, benzyl methyl ethoxysilane, benzyl triethoxysilane, dibenzyl dimethoxysilane, dibenzyl diethoxysilane, 3-acetoxy propyl trimethoxysilane, 3-acryloxy propyl trimethoxysilane, aryl trimethoxysilane, aryl triethoxysilane, 4-aminobutyl triethoxysilane, (aminoethylaminomethyl)phenethyltrimethoxysilane, N-(2-aminoethyl)-3-aminopropylmethyldimethoxysilane, N-(2-aminoethyl)-3-aminopropyltrimethoxysilane, 6-(aminohexylaminopropyl)trimethoxysilane, p-aminophenyl trimethoxysilane, p-aminophenyl ethoxysilane, m-aminophenyl trimethoxysilane, m-aminophenyl ethoxysilane, 3-aminopropyl trimethoxysilane, 3-aminopropyl triethoxysilane, ω-aminoundecyl trimethoxysilane, aminotriethoxysilane, benzooxathiepine dimethyl ester, 5-(bicycleheptenyl)triethoxysilane, bis(2-hydroxyethyl)-3-aminopropyltriethoxysilane, 8-bromooctyl trimethoxysilane, bromophenyl trimethoxysilane, 3-bromopropyl trimethoxysilane, n-butyl trimethoxysilane, 2-chloromethyl triethoxysilane, chloromethyl methyl diethoxysilane, chloromethyl methyl diisopropoxysilane, p-(chloromethyl)phenyltrimethoxysilane, chloromethyl triethoxysilane, chlorophenyl triethoxysilane, 3-chloropropyl methyl dimethoxysilane, 3-chloropropyl triethoxysilane, 3-chloropropyl trimethoxysilane, 2-(4-chlorosulfonylphenyl)ethyltrimethoxysilane, 2-cyanoethyl triethoxysilane, 2-cyanoethyl trimethoxysilane, cyanomethyl phenetyl triethoxysilane, 3-cyanopropyl triethoxysilane, 2-(3-cyclohexenyl)ethyltrimethoxysilane, 2-(3-cyclohecenyl)ethyltriethoxysilane, 3-cyclohexenyl trichlorosilane, 2-(3-cyclohexenyl)ethyltrichlorosilane, 2-(3-cyclohexenyl)ethyldimethylchlorosilane, 2-(3-cyclohexenyl)ethylmethyldichlorosilane, cyclohexyl dimethyl chlorosilane, cyclohexyl ethyl dimethoxysilane, cyclohexyl methy dichlorosilane, cyclohexyl methyl dimethoxysilane, (cyclohexylmethyl)trichlorosilane, cyclohexyl trichlorosilane, cyclohexyl trimethoxysilane, cyclooctyl trichlorosilane, (4-cyclooctenyl)trichlorosilane, cyclopentyl trichlorosilane, cyclopentyl trimethoxysilane, 1,1-diethoxy-1-silacyclopenta-3-ene, 3-(2,4-dinitrophenylamino)propyltriethoxysilane, (dimethylchlorosilyl)methyl-7,7-dimethylnopinane, (cyclohexylaminomethyl)methyldiethoxysilane, (3-cyclopentadienylpropyl)triethoxysilane, N,N-diethyl-3-aminopropyltrimethoxysilane, 2-(3,4-epoxycyclohexyl)ethyltrimethoxysilane, 2-(3,4-epoxysilanecyclohexyl)ethyltrimethoxysilane, (furfuryl oxymethyl)triethoxysilane, 2-hydroxy-4-(3-triethoxypropoxy)diphenylketone, 3-(p-methoxyphenyl)propylmethyldichlorosilane, 3-(p-methoxyphenyl)propyltrichlorosilane, p-(methylphenethyl)methyldichlorosilane, p-(methylphenethyl)trichlorosilane, p-(methylphenetyl)dimethylchlorosilane, 3-morpholino propyl trimethoxysilane, (3-glycidoxypropyl)methyldiethoxysilane, 3-glycidoxypropyltrimethoxysilane, 1,2,3,4,7,7-hexachloro-6-methyldiethoxysilyl-2-norbornen, 1,2,3,4,7,7-hexachloro-6-triethoxysilyl-2-norbornene, 3-iodopropyl trimethoxysilane, 3-isocyanate propyl triethoxysilane, (mercaptomethyl)methyldiethoxysilane, 3-mercaptopropylmethyldimethoxysilane, 3-mercaptopropyl dimethoxysilane, 3-mercaptopropyl triethoxysilane, 3-methacryloxypropyl methyldiethoxysilane, 3-methacryloxypropyl trimethoxysilane, methyl{2-(3-trimethoxysilylpropylamino)ethylamino}-3-propionate, 7-octenyltrimethoxysilane, R—N-α-phenethyl-N′-triethoxysilylpropylurea, S—N-α-phenethyl-N′-triethoxysilylpropylurea, phenethyl trimethoxysilane, phenethyl methyl dimethoxysilane, phenethyl dimethyl methoxysilane, phenethyl dimethoxysilane, phenethyl diethoxysilane, phenethyl methyl diethoxysilane, phenethyl dimethyl ethoxysilane, phenethyl triethoxysilane, (3-phenylpropyl)dimethylchlorosilane, (3-phenylpropyl)methyldichlorosilane, N-phenylaminopropyl trimethoxysilane, N-(triethoxysilylpropyl)dansylamide, N-(3-triethoxysilylpropyl)-4,5-dihydroimidazole, 2-(triethoxysilylethyl)-5-(chloroacetoxy)bicycloheptane, (S)—N-triethoxysilylpropyl-O-methyl carbamate, 3-(triethoxysilylpropyl)-p-nitrobenzamide, 3-(triethoxysilyl)propyl succinic anhydride, N-[5-(trimethoxysilyl)-2-aza-1-oxo-pentyl]caprolactone, 2-(trimethoxysilylethyl)pyridine, N-(trimethoxysilylethyl)benzyl-N,N,N-trimethyl ammonium chloride, phenyl vinyl diethoxysilane, 3-thiocyanate propyl triethoxysilane, (tridecafluoro-1,1,2,2-tetrahydrooctyl)triethoxysilane, N-(3-(triethoxysilyl)propyl)phthaamic acid, (3,3,3-trifluoropropyl)methyl dimethoxysilane, (3,3,3-trifluoropropyl)trimethoxysilane, 1-trimethoxysilyl-2-(chloromethyl)phenylethane, 2-(trimethoxysilyl)ethylphenylsulfonylamide, p-trimethoxysilylethyl-2-pyridine, trimethoxy silylpropyl diethylene triamine, N-(3-trimethoxysilylpropyl)pyrrole, N-trimethoxysilylpropyl-N,N,N-tributylammoniumbromide, N-trimethoxysilylpropyl-N,N,N-tributylammoniumchloride, N-trimethoxysilylpropyl-N,N,N-trimethylammoniumchloride, vinyl methyl diethoxysilane, vinyl triethoxysilane, vinyl trimethoxysilane, vinyl methyl dimethoxysilane, vinyl methyl methoxysilane, vinyl dimethyl ethoxysilane, vinyl methyl dichlorosilane, vinyl phenyl dichlorosilane, vinyl phenyl diethoxysilane, vinyl phenyl dimethylsilane, vinyl phenyl methyl chlorosilane, vinyl triphenoxysilane, vinyl tris-t-butoxysilane, adamantly ethyl trichlorosilane, aryl phenyl trichlorosilane, (aminoethylaminomethyl)phenethyltrimethoxysilane, 3-aminophenoxy dimethyl vinylsilane, phenyl trichlorosilane, phenyl dimethyl chlorosilane, phenyl methyl dichlorosilane, benzyl trichlorosilane, benzyl dimethyl chlorosilane, benzyl methyl dichlorosilane, phenethyl diisopropyl chlorosilane, phenethyl trichlorosilane, phenethyl dimethyl chlorosilane, phenethyl methyl dichlorosilane, 5-(bicycloheptenyl)trichlorosilane, 5-(bicycloheptenyl)triethoxysilane, 2-(bicycloheptyl)dimethylchlorosilane, 2-(bicycloheptyl)trichlorosilane, 1,4-bis(trimethoxysilylethyl)benzyl, bromophenyl trichlorosilane, 3-phenoxypropyl dimethylchlorosilane, 3-phenoxypropyl trichlorosilane, t-butylphenyl chlorosilane, t-butylphenyl methoxysilane, t-butylphenyl dichlorosilane, p-(t-butyl)phenethyldimethylchlorosilane, p-(t-butyl)phenethyltrichlorosilane, 1,3-(chlorodimethylsilylmethyl)heptacosane, ((chloromethyl)phenylethyl)dimethylchlorosilane, ((chloromethyl)phenylethyl)methyldichlorosilane, ((chloromethyl)phenylethyl)trichlorosilane, ((chloromethyl)phenylethyl)trimethoxysilane, chlorophenyl trichlorosilane, 2-cyanoethyl trichlorosilane, 2-cyanoethyl methyl dichlorosilane, 3-cyanopropyl methyl diethoxysilane, 3-cyanopropyl methyl dichlorosilane, 3-cyanopropyl methyl dichlorosilane, 3-cyanopropyl dimethyl ethoxysilane, 3-cyanopropyl methyl dichlorosilane, 3-cyanopropyl trichlorosilane, and fluorinated alkylsilane, and these can be used alone or in combination of two or more kinds thereof.

Among these, it is preferable to use hexamethyl disilazane for a hydrophobic treatment. In this manner, it is possible to increase the hydrophobicity of the grain 111. Further, it is possible to easily and reliably increase the uniformity of the hydrophobic treatment in each grain 111 or in each region of the surface of grains 111 (including the surface in the inside of the pores 1111).

In a case where the hydrophobic treatment using a silane compound in a liquid phase, it is possible to suitably promote a desirable reaction and to form a chemical adsorption film of a silane compound by immersing the grains 111 (mother particles) to which the hydrophobic treatment is applied in a liquid containing a silane compound.

In a case where the hydrophobic treatment using a silane compound in a vapor phase, it is possible to suitably promote a desirable reaction and to form a chemical adsorption film of a silane compound by exposing the grains 111 (mother particles) to which the hydrophobic treatment is applied to steam of a silane compound.

The average particle diameter of the grains 111 constituting the powder for three-dimensional forming, which is not particularly limited, is preferably in the range of 1 μm to 25 μm and more preferably in the range of 1 μm to 15 μm. In this manner, it is possible to make the mechanical strength of the three-dimensional structure 10 particularly excellent, to more effectively prevent the generation of unintentional unevenness in the three-dimensional structure 10 to be produced, and to make the dimensional precision of the three-dimensional structure 10 particularly excellent. Further, it is possible to make the fluidity of the powder for three-dimensional forming and the fluidity of the paste-like composition (composition for three-dimensional forming) 11 including the powder for three-dimensional forming particularly excellent and to make the productivity of the three-dimensional structure 10 particularly excellent.

Moreover, in the invention, the average particle diameter means the average particle diameter on the volume basis and can be acquired by adding a sample to methanol and measuring a dispersion liquid, in which the sample is dispersed by an ultrasonic disperser for 3 minutes, with a particle size distribution measuring device (TA-II type, manufactured by COULTER ELECTRONICS, Inc.) according to a coulter counter method using an aperture having a diameter of 50 μm.

Dmax of the grains 111 constituting the powder for three-dimensional forming is preferably in the range of 3 μm to 40 μm and more preferably in the range of 5 μm to 30 μm. In this manner, it is possible to make the mechanical strength of the three-dimensional structure 10 particularly excellent, to more effectively prevent the generation of unintentional unevenness in the three-dimensional structure 10 to be produced, and to make the dimensional precision of the three-dimensional structure 10 particularly excellent. Further, it is possible to make the fluidity of the powder for three-dimensional forming and the fluidity of the composition (composition for three-dimensional forming) 11 including the powder for three-dimensional forming particularly excellent and to make the productivity of the three-dimensional structure 10 particularly excellent.

The porosity of the powder 111 constituting the powder for three-dimensional forming is preferably 50% or more and more preferably in the range of 55% to 90%. In this manner, it is possible to sufficiently have a space (pores 1111) for which the binder enters, to make the mechanical strength of the grains 111 excellent, and, as a result, to make the mechanical strength of the three-dimensional structure 10 formed with the binder 121 infiltrating into the pores 1111 particularly excellent. Further, in the invention, the porosity of the grains (particles) means the ratio (volume ratio) of the pores present in the inside of the grains with respect to the apparent volume of the grains and is a value represented by “{(ρ0−ρ))/ρ0}×100” when the density of the grains is set as ρ[g/cm³] and the true density of the constituent material of the grains is set as ρ0[g/cm³].

The average pore diameter (pore diameter) of the grains 111 is preferably 10 nm or more and more preferably in the range of 50 nm to 300 nm. In this manner, it is possible to make the mechanical strength of the three-dimensional structure 10 which is finally obtained particularly excellent. Further, in a case where the binding solution 12 (colored ink) including a pigment is used for producing the three-dimensional structure 10, it is possible to suitably hold the pigment in the pores 1111 of the grains 111. Accordingly, it is possible to prevent unintentional diffusion of the pigment and to reliably form a high-definition image.

The shape of the grains 111 constituting the powder for three-dimensional forming is not particularly limited, but the grains having a spherical shape are preferable. In this manner, it is possible to make the fluidity of the powder for three-dimensional forming and the fluidity of the paste-like composition (composition for three-dimensional forming) 11 including the powder for three-dimensional forming particularly excellent, to make the productivity of the three-dimensional structure 10 particularly excellent, to effectively prevent the generation or the like of unintentional unevenness in the three-dimensional structure 10 to be produced, and to make the dimensional precision of the three-dimensional structure 10 particularly excellent.

The porosity of the powder for three-dimensional forming is preferably in the range of 70% to 98% and more preferably in the range of 75% to 97.7%. In this manner, it is possible to make the mechanical strength of the three-dimensional structure 10 particularly excellent. Further, it is possible to make the fluidity of the powder for three-dimensional forming and the fluidity of the composition (composition for three-dimensional forming) 11 including the powder for three-dimensional forming particularly excellent, to make the productivity of the three-dimensional structure 10 particularly excellent, to effectively prevent the generation or the like of unintentional unevenness in the three-dimensional structure 10 to be produced, and to make the dimensional precision of the three-dimensional structure 10 particularly excellent. Moreover, in the invention the porosity of the powder for three-dimensional forming means a ratio of the total of the volume of pores included in the entirety of grains (particles) constituting the powder for three-dimensional forming and the volume of pores present among grains (particles) with respect to the capacity of the container, and is a value represented by “{(P0−P)/P0}×100” when the bulk density of the powder for three-dimensional forming is set as P [g/cm³] and the true density of the constituent material of the powder for three-dimensional forming is set as P0 [g/cm³] in a case where the container having a predetermined capacity (for example, 100 mL) is filled with the powder for three-dimensional forming.

The content ratio of the powder for three-dimensional forming in the composition (composition for three-dimensional forming) 11 is preferably in the range of 10% by mass to 90% by mass and more preferably in the range of 15% by mass to 65% by mass. In this manner, it is possible to make the fluidity of the composition (composition for three-dimensional forming) 11 sufficiently excellent and to make the mechanical strength of the three-dimensional structure 10 which is finally obtained particularly excellent.

### Water-Soluble Resin

The composition 11 may include plural grains 111 and a water-soluble resin 112.

By including the water-soluble resin 112, the grains 111 are bonded (temporary fixing) to each other in a region for which the binding solution 12 of the second layer 1 is not provided (see FIG. 5) and unintentional scattering of the grains 111 can be effectively prevented. In this manner, it is possible to further improve the safety of an operator and the dimensional precision of the three-dimensional structure 10 to be produced.

Further, in a case where the grains 111 are subjected to the hydrophobic treatment even when the water-soluble resin 112 is included, the water-soluble resin 112 is effectively prevented from entering the pores 1111 of the grains 111. Accordingly, the function of the water-soluble resin 112 which temporarily fixes the grains 111 to each other is reliably exhibited. In addition, a problem in that a space for which the binder 121 enters may not be secured because the water-soluble resin 112 enters the pores 1111 of the grains 111 in advance can be reliably prevented.

It is preferable that at least a part of the water-soluble resin 112 is soluble in water. For example, the solubility in water at 25° C. (mass of the water-soluble resin soluble in 100 g of water) is preferably 5 [g/100 g of water] or more and more preferably 10 [g/100 g of water] or more.

Examples of the water-soluble resin 112 include synthetic polymers such as polyvinyl alcohol (PVA), polyvinylpyrrolidone (PVP), polycaprolactone diol, sodium polyacrylate, polyacrylamide, modified polyamide, polyethylene imine, polyethylene oxide, and a random copolymer of ethylene oxide and propylene oxide; natural polymers such as cornstarch, mannan, pectin, agar, alginic acid, dextran, glue, and gelatin; and semi-synthetic polymers such as carboxymethyl cellulose, hydroxyethyl cellulose, oxidized starch, and modified starch, and these can be used alone or in combination of two or more kinds thereof.

Specific examples of the water-soluble resin product include methyl cellulose (Metolose SM-15, manufactured by Shin-Etsu Chemical Co., Ltd.), hydroxyethyl cellulose (AL-15, manufactured by Fuji Chemical Industries, Ltd.), hydroxypropyl cellulose (HPC-M, manufactured by NIPPON SODA CO., LTD.), carboxymethyl cellulose (CMC-30, manufactured by Nichirin Chemical Industries, Ltd.), sodium starch phosphate ester (I) (HOSTER 5100, manufactured by Matsutani Chemical Industry Co., Ltd.), polyvinylpyrrolidone (PVP K-90, manufactured by Tokyo Chemical Co., Ltd.), methyl vinyl ether/maleic acid anhydride polymer (AN-139, manufactured by GAF Gauntlet, Inc.), polyacrylamide (manufactured by Wako Pure Chemical Industries, Ltd.), modified polyamide (modified nylon, AQ NYLON, manufactured by Toray Industries, Inc.), polyethylene oxide (PEO-1, manufactured by Steel Chemical Co., Ltd., ALKOX, manufactured by Meisei Chemical Industries Co., Ltd.), a random copolymer of ethylene oxide and propylene oxide (ALKOX EP, manufactured by Meisei Chemical Industries Co., Ltd.), sodium polyacrylate (manufactured by Wako Pure Chemical Industries, Ltd.), and carboxy vinyl polymer/cross-linked acrylic water-soluble resin (AQUPEC, manufactured by Sumitomo Seika Chemicals Co., Ltd.).

Among these, in a case where the water-soluble resin 112 is polyvinyl alcohol, it is possible to make the mechanical strength of the three-dimensional structure 10 particularly excellent. Further, by adjusting the degree of saponification or the degree of polymerization, it is possible to more suitably control properties of the water-soluble resin 112 (for example, water-soluble properties or water resistance properties) and properties of the composition 11 (for example, the viscosity, the fixed power of the grains 111, or the wettability). Accordingly, it is possible to more suitably respond to production of various three-dimensional structures 10. Further, polyvinyl alcohol is low in price among various kinds of water-soluble resins and the supply thereof is stabilized. Therefore, it is possible to produce a stabilized three-dimensional structure 10 while reducing the production cost.

In a case where the water-soluble resin 112 includes polyvinyl alcohol, the degree of saponification of the polyvinyl alcohol is preferably in the range of 85 to 90. In this manner, it is possible to suppress a decrease in solubility of polyvinyl alcohol in water. Accordingly, it is possible to more effectively suppress a decrease in adhesiveness between adjacent layers in a case where the composition 11 contains water.

In a case where the water-soluble resin 112 contains polyvinyl alcohol, the degree of polymerization of the polyvinyl alcohol is preferably in the range of 300 to 1000. In this manner, in the case where the composition 11 contains water, it is possible to make the mechanical strength of each layer or the adhesiveness between adjacent layers particularly excellent.

Further, in a case where the water-soluble resin 112 is polyvinylpyrrolidone (PVP), the following effects can be obtained. That is, since polyvinylpyrrolidone has excellent adhesiveness with respect to various materials such as glass, metal, or plastic, it is possible to make the strength or stability of the shape of a portion for which the binding solution 12 is not provided in the second layer 1 particularly excellent and to make the dimensional precision of the three-dimensional structure 10 which is finally obtained particularly excellent. Further, since polyvinylpyrrolidone shows excellent solubility in various organic solvents, in a case where the composition 11 includes an organic solvent, it is possible to make the fluidity of the composition 11 particularly excellent, to suitably form the second layer 1 in which unintentional unevenness in thickness is more effectively prevented, and to make the dimensional precision of the three-dimensional structure 10 which is finally obtained particularly excellent. Further, since polyvinylpyrrolidone shows excellent solubility in water, grains which are not bonded with the binder 121 can be easily and reliably removed from the grains 111 constituting each second layer 1 during the unbonded particle removing process (after forming is completed). Moreover, since polyvinylpyrrolidone has suitable affinity for the powder for three-dimensional forming, polyvinylpyrrolidone is unlikely to sufficiently enter the pores 1111 as described above, but the wettability with respect to the surface of the grains 111 is relatively high. Therefore, it is possible to more effectively exhibit the function of fixing the grains temporarily as described above. Further, since polyvinylpyrrolidone has excellent affinity for various colorants, unintentional diffusion of a colorant can be effectively prevented in a case where the binding solution 12 including a colorant is used. In addition, when the paste-like composition 11 contains polyvinylpyrrolidone, it is possible to effectively prevent bubbles from being rolled in the compound 11 and to more effectively prevent the generation of defects due to rolling-in of bubbles.

In a case where the water-soluble resin 112 contains polyvinylpyrrolidone, the weight average molecular weight of the polyvinylpyrrolidone is preferably in the range of 10000 to 1700000 and more preferably in the range of 30000 to 1500000. In this manner, the above-described functions can be more effectively exhibited.

Further, in a case where the water-soluble resin 112 is polycaprolactone diol, it is possible to make the composition 11 have a pellet shape and to more effectively prevent unintentional scattering or the like of the grains 111. Accordingly, the handleability (easiness of handling) of the composition 11 is improved, and accordingly, it is possible to improve the stability of an operator and the dimensional precision of the three-dimensional structure 10 to be produced and to allow the three-dimensional structure 10 to be melted at a relatively low temperature. Therefore, it is possible to suppress the energy and the cost necessary for production of the three-dimensional structure 10 and to make the productivity of the three-dimensional structure 10 sufficiently excellent.

In a case where the water-soluble resin 112 contains polycarolactone diol, the weight average molecular weight of the polycarolactone diol is preferably in the range of 10000 to 1700000 and more preferably in the range of 30000 to 1500000. In this manner, the above-described functions can be more effectively exhibited.

In the composition 11, it is preferable that the water-soluble resin 112 is in a state of a liquid (for example, a dissolved state or a melted state) at least during the first layer forming process. In this manner, it is possible to easily and reliably further improve the uniformity in thickness of the second layer 1 to be formed using the composition 11.

### Solvent

The composition 11 may include a volatile solvent (not illustrated in FIG. 5) in addition to the above-described components.

In this manner, it is possible to make the composition 11 have a paste shape, to make the fluidity of the composition 11 stably excellent, and to make the productivity of the three-dimensional structure 10 particularly excellent. The reason for this is as follows. That is, in the invention, it is preferable to decrease the fluidity of a layer formed using the composition from viewpoints of stability of the shape of the layer and preventing unintentional wetting spreadability of the binding solution at the time of forming a bonding portion (bonding process), but the fluidity of the layer can be decreased by removing (volatilizing) a solvent in a case where the composition contains the solvent. Meanwhile, for example, at the time of forming a layer, in a case where components contained in the composition are melted, the temperature of the composition (layer) needs to be decreased in order to decrease the fluidity of the layer formed using the composition, but adjustment of the fluidity by means of removing the solvent can be easily and rapidly performed compared to adjustment of the fluidity by means of adjusting the temperature thereof. In addition, when the fluidity is adjusted by adjusting the temperature thereof, it is difficult to stably control the fluidity of the layer because the fluidity of the layer relatively largely fluctuates due to the temperature. Meanwhile, when the fluidity is adjusted by removing the solvent, the fluidity of the layer can be easily and stably controlled. Further, in a case where components contained in the composition are to be melted, heating and cooling of the composition need to be repeatedly performed and this process requires a relatively large amount of energy. Meanwhile, when a solvent is used, the amount of energy to be used can be suppressed. Therefore, it is preferable to use a solvent from a viewpoint of saving energy.

Further, when the composition 11 contains a solvent, since it is possible to make the adhesiveness between the second layer 1 provided on the lower side and the first layer 1′ provided on the upper side such that the first layer 1′ and the second layer 1 are adjacent to each other particularly excellent during the process of producing the three-dimensional structure 10, it is possible to effectively prevent generation of unintentional defects in the second layer 1 to be formed during the film thickness adjusting process. Accordingly, it is possible to more reliably make the dimensional precision of the three-dimensional structure 10 particularly excellent.

In addition, it is possible to make the adhesiveness the adjacent second layers 1 constituting the three-dimensional structure 10 particularly excellent and to make the mechanical strength and the durability of the three-dimensional structure 10 particularly excellent.

It is preferable that a solvent dissolves the water-soluble resin 112. In this manner, it is possible to make the fluidity of the composition 11 excellent and to more effectively prevent unintentional unevenness in thickness of the second layer 1. Further, when the second layer 1 in a state in which a solvent is removed is formed, it is possible to adhere the water-soluble resin 112 to the grains 111 with excellent uniformity over the entire second layer 1 and to more effectively prevent the generation of unintentional unevenness in composition. Therefore, it is possible to more effectively prevent the generation of unintentional unevenness in mechanical strength in each region of the three-dimensional structure 10 which is finally obtained and to further improve the reliability of the three-dimensional structure 10. Further, in the configuration illustrated in FIG. 5, a solvent is not illustrated and the water-soluble resin 112 is adhered to a part of the outer surface of the grains 111 in a state in which the water-soluble resin 112 is deposited. However, in a case where a solvent is included, the water-soluble resin 112 is included in the composition 11 in a state of being dissolved in the solvent and the solvent may be present in a state of wetting the surface of the grains 111 (for example, a surface other than the surface of the pores 1111 of the grains 111).

Examples of the solvent constituting the composition 11 include water; an alcohol-based solvent such as methanol, ethanol, or isopropanol; a ketone-based solvent such as methyl ethyl ketone or acetone; a glycol ether-based solvent such as ethylene glycol monoethyl ether or ethylene glycol monobutyl ether; a glycol ether acetate-based solvent such as propylene glycol 1-monomethylether 2-acetate or propylene glycol 1-monoethylether 2-acetate; polyethylene glycol; and polypropylene glycol, and these can be used alone or in combination of two or more kinds thereof.

It is preferable that the composition 11 contains water among those described above. In this manner, it is possible to reliably dissolve the water-soluble resin 112 and to make the fluidity of the composition 11 and the uniformity of the composition of the second layer 1 particularly excellent. Further, water can be easily removed after the layer is formed and does not adversely affect the three-dimensional structure 10 when water remains therein. Moreover, water is advantageous from viewpoints of stability with respect to a human body and environmental problems.

In a case where the composition 11 includes a solvent, the content ratio of the solvent in the composition 11 is preferably in the range of 5% by mass to 75% by mass and more preferably in the range of 35% by mass to 70% by mass. In this manner, since effects generated when a solvent is included are better exhibited and the solvent can be easily removed in a short period of time during the process of producing the three-dimensional structure 10, a solvent is advantageous from a viewpoint of improving productivity of the three-dimensional structure 10.

Particularly, in a case where the composition 11 includes water as a solvent, the content ratio of water in the composition 11 is preferably in the range of 20% by mass to 73% by mass and more preferably in the range of 50% by mass to 70% by mass. In this manner, effects described above are better exhibited.

### Other Components

Further, the composition 11 may contain components other than those described above. Examples of the components include a polymerization initiator, a polymerization accelerator, a permeation promotor, a wetting agent (moisturizing agent), a fixing agent, a fungicide, a preservative, an antioxidant, a UV absorber, a chelating agent, and a pH adjusting agent.

### Binding Solution

Hereinafter, the binding solution used to produce the three-dimensional structure of the invention will be described in detail.

The binding solution 12 contains at least the binder 121.

### Binder

The binder 121 is not particularly limited as long as the binding solution has a function of binding the grains 111, but a binder including pores 1111 described below as the grains 111 and having hydrophobicity (lipophilicity) in a case of using a binding solution to which a hydrophobic treatment is applied is preferable. In this manner, the affinity between the binding solution 12 and the grains 111 to which a hydrophobic treatment is applied can be increased and the binding solution 12 can suitably enter the pores 1111 of the grains 111 to which the hydrophobic treatment is applied by providing the binding solution 12 for the second layer 1. As a result, the anchor effect due to the binder 121 is remarkably exhibited and thus it is possible to make the mechanical strength of the three-dimensional structure 10 which is finally obtained particularly excellent. In addition, it is preferable that the hydrophobic binder 121 has sufficiently low affinity for water. For example, the binding solution whose solubility in water at 25° C. is 1 [g/100 g of water] or less is preferable.

Examples of the binder 121 include various photocurable resins such as a thermoplastic resin, a thermosetting resin, a visible photocurable resin that is cured by light in a visible light region (phpotocurable resin in the narrow sense), a UV curable resin, and an infrared curable resin; and an X-ray curable resin, and these can be used alone or in combination of two or more kinds thereof. It is preferable that the binder 121 includes a curable resin from a viewpoint of mechanical strength of the three-dimensional structure 10 to be obtained and the productivity of the three-dimensional structure 10. Further, among various curable resins, a UV thermosetting resin (polymerizable compound) is particularly preferable from viewpoints of the mechanical strength of the three-dimensional structure 10, the productivity of the three-dimensional structure 10, and the storage stability of the binding solution 12.

As the UV curable resin (polymerizable compound), a resin in which addition polymerization or ring-opening polymerization is started by radicals or cations generated from a photopolymerization initiator due to irradiation with UV rays and a polymer is generated is preferably used. Examples of the polymerization mode of the addition polymerization include a radical, a cation, an anion, a metathesis, and coordination polymerization, and examples of the polymerization mode of the ring-opening polymerization include a cation, an anion, a radical, a metathesis, and coordination polymerization.

As an addition-polymerizable compound, a compound having at least one ethylenically unsaturated double bond can be exemplified. As the addition-polymerizable compound, a compound having at least one and preferably two or more terminal ethylenically unsaturated bonds can be preferably used.

The ethylenically unsaturated polymerizable compound has a chemical form of a monofunctional polymerizable compound and a polyfunctional polymerizable compound or a mixture of these two. Examples of the monofunctional polymerizable compound include unsaturated carboxylic acid (for example, acrylic acid, methacrylic acid, itaconic acid, crotonic acid, isocrotonic acid, or maleic acid), esters thereof, and amides. As the polyfunctional polymerizable compounds, esters of unsaturated carboxylic acid and an aliphatic polyhydric alcohol compound and amides of unsaturated carboxylic acid and an aliphatic amine compound are used.

Further, an addition reaction product of unsaturated carboxylic acid esters or amides having a nucleophilic substituent such as a hydroxyl group, an amino group, or a mercapto group; isocyanates; and epoxys, and a dehydration condensation reaction product with carboxylic acid can be used. Further, an addition reaction product of unsaturated carboxylic acid esters or amides having an electrophilic substituent such as an isocyanate group or an epoxy group; alcohols; amines; and thiols, and a substitution reaction product of unsaturated carboxylic acid esters or amides having a dissociable substituent such as a halogen group or a tosyloxy group; alcohols; amines; or thiols can be used.

Specific examples of a radical polymerizable compound which is an ester between unsaturated carboxylic acid and an aliphatic polyhydric alcohol compound include (meth)acrylic acid ester as a typical example, a monofunctional (meth)acrylic acid ester, and a polyfunctional (meth)acrylic acid ester.

Specific examples of the monofunctional (meth)acrylate include tolyloxyethyl(meth)acrylate, phenyloxyethyl(meth)acrylate, cyclohexyl(meth)acrylate, ethyl(meth)acrylate, methyl(meth)acrylate, isobornyl(meth)acrylate, and tetrahydrofurfuryl(meth)acrylate.

Specific examples of the difunctional (meth)acrylate include ethyleneglycol di(meth)acrylate, triethyleneglycol di(meth)acrylate, 1,3-butanediol di(meth)acrylate, tetramethyleneglycol di(meth)acrylate, propyleneglycol di(meth)acrylate, neopentylglycol di(meth)acrylate, hexanediol di(meth)acrylate, 1,4-cyclohexanediol di(meth)acrylate, tetraethyleneglycol di(meth)acrylate, pentaerythritol di(meth)acrylate, and dipentaerythritol di(meth)acrylate.

Specific examples of the trifuctional (meth)acrylate include trimethylolpropane tri(meth)acrylate, trimethylolethane tri(meth)acrylate, alkyleneoxide-modified tri(meth)acrylate of trimethylolpropane, pentaerythritol tri(meth)acrylate, dipentaerythritol tri(meth)acrylate, trimethylolpropane tri((meth)acryloyloxypropyl)ether, isocyanuric acid alkyleneoxide-modified tri(meth)acrylate, propionic acid dipentaerythritol tri(meth)acrylate, tri((meth)acryloyloxyethyl)isocyanurate, hydroxypivalaldehyde-modified dimethylolpropane tri(meth)acrylate, and sorbitol tri(meth)acrylate.

Specific examples of the tetrafunctional (meth)acrylate include pentaerythritol tetra(meth)acrylate, sorbitol tetra(meth)acrylate, ditrimethylolpropane tetra(meth)acrylate, propionic acid dipentaerythritol tetra(meth)acrylate, and ethoxylated pentaerythritol tetra(meth)acrylate.

Specific examples of the pentafunctional (meth)acrylate include sorbitol penta(meth)acrylate and dipentaerythritol penta(meth)acrylate.

Specific examples of the hexafunctional (meth)acrylate include dipentaerythritol hexa(meth)acrylate, sorbitol hexa(meth)acrylate, alkyleneoxide-modified hexa(meth)acrylate of phosphazene, and caprolactone-modified dipentaerythritol hexa(meth)acrylate.

Examples of the polymerizable compounds other than (meth)acrylate include itaconic acid ester, crotonic acid ester, isocrotonic acid ester, and maleic acid ester.

Examples of the itaconic acid ester include ethylene glycol diitaconate, propylene glycol diitaconate, 1,3-butanediol diitaconate, 1,4-butanediol diitaconate, tetramethylene glycol diitaconate, pentaerythritol diitaconate, and sorbitol tetraitaconate.

Examples of crotonic acid ester include ethylene glycol dicrotonate, tetramethylene glycol dicrotonate, pentaerythritol dicrotonate, and sorbitol dicrotonate.

Examples of isocrotonic acid ester include ethylene glycol diisocrotonate, pentaerythritol diisocrotonate, and sorbitol tetraisocrotonate.

Examples of maleic acid ester include ethylene glycol dimaleate, triethylene glycol dimaleate, pentaerythritol dimaleate, and sorbitol tetramaleate.

Examples of other esters include aliphatic alcohol esters described in JP-B-46-27926, JP-B-51-47334, JP-A-57-196231; esters having an aromatic skeleton described in JP-A-59-5240, JP-A-59-5241, and JP-A-2-226149, and esters containing an amino group described in JP-A-1-165613.

Specific examples of monomers of amide between unsaturated carboxylic acid and an aliphatic amine compound include methylene bis-acrylamide, methylene bis-methacrylamide, 1,6-hexamethylene bis-acrylamide, 1,6-hexamethylene bis-methacrylamide, diethylenetriamine trisacrylamide, xylylene bis-acrylamide, and xylylene bis-methacrylamide.

Preferred examples of other amide-based monomers include monomers having a cyclohexylene structure described in JP-B-54-21726 can be exemplified.

Further, a urethane-based addition polymerizable compound to be produced using an addition reaction between isocyanate and a hydroxyl group is preferable and specific examples thereof include a vinyl urethane compound containing two or more polymerizable vinyl groups in one molecule which is obtained by adding a vinyl monomer containing a hydroxyl group represented by the following formula (1) to a polyisocyanate compound having two or more isocyanate groups in one molecule described in JP-B-48-41708.

CH₂═C(R¹)COOCH₂CH(R²)OH (1)

(in this case, R¹ and R² each independently represent H or CH₃ in the formula (1))

In the invention, a cationic ring-opening polymerizable compound having one or more cyclic ether groups such as an epoxy group or an oxetane group in one molecule can be preferably used as a UV curable resin (polymerizable compound).

Examples of the cationically polymerizable compound include curable compounds containing a ring-opening polymerizable group, and, among these, a heterocyclic group-containing curable compound is particularly preferable. Examples of the curable compound include cycle imino ethers such as an epoxy derivative, an oxetane derivative, a tetrahydrofuran derivative, a cyclic lactone derivative, a cyclic carbonate derivative, and an oxazoline derivative, and vinyl ethers. Among these, an epoxy derivative, an oxetane derivative, and vinyl ethers are preferable.

Preferred examples of the epoxy derivative include monofunctional glycidyl ethers, polyfunctional glycidyl ethers, monofunctional alicyclic epoxys, and polyfunctional alicyclic epoxys.

Specific examples of the compounds of glycidyl ethers include diglycidyl ethers (for example, ethylene glycol diglycidyl ether and bisphenol A diglycidyl ether); tri- or higher functional glycidyl ethers (for example, trimethylol ethane triglycidyl ether, trimethylol propane triglycidyl ether, glycerol triglycidyl ether, and triglycidyl trishydroxyethyl isocyanurate); tetra- or higher functional glycidyl ethers (for example, sorbitol tetraglycidyl ether, pentaerythritol tetraglycidyl ether, polyglycidyl ether of a cresol novolac resin, and polyglycidyl ether of a phenyl novolac resin); alicyclic epoxys (for example, CELLOXIDE 2021P, CELLOXIDE 2081, Epolead GT-301, and Epolead GT-401 (all manufactured by Daicel Chemical Industries, Ltd.)); EHPE (manufactured by Daicel Chemical Industries, Ltd.); polycyclohexyl epoxy methyl ether of a phenol novolac resin; oxetanes (for example, OX-SQ and PNOX-1009 (both manufactured by Toagosei Co., Ltd.).

As the polymerizable compound, an alicyclic epoxy derivative can be preferably used. The term “alicyclic epoxy group” means a partial structure obtained by epoxidizing a double bond of a cycloalkene ring such as a cyclopentene group or a cyclohexene group with a suitable oxidant such as hydrogen peroxide or peracid.

As the alicyclic epoxy compound, polyfunctional alicyclic epoxys having two or more cyclohexene oxide groups or cyclopentene oxide groups in one molecule are preferable. Specific examples of the alicyclic epoxy compound include 4-vinylcyclohexene dioxide, (3,4-epoxychclohexyl)methyl-3,4-epoxycyclohexyl carboxylate, di(3,4-epoxycyclohexyl)adipate, di(3,4-epoxycyclohexylmethyl)adipate, bis(2,3-epoxycyclopentyl)ether, di(2,3-epoxy-6-methylcyclohexylmethyl)adipate, and dicyclopentadiene dioxide.

The glycidyl compound having a normal epoxy group which does not include an alicyclic structure in a molecule may be used alone or in combination with the above-described alicyclic epoxy compound.

As such a normal glycidyl compound, for example, a glycidyl ether compound or a glycidyl ester compound can be exemplified, but a combination with a glycidyl ether compound is preferable.

Specific examples of the glycidyl ether compound include an aromatic glycidyl ether compound such as 1,3-bis(2,3-epoxypropyloxy)benzene, a bisphenol A type epoxy resin, a bisphenol F type epoxy resin, a phenol.novolac type epoxy resin, a cresol.novolac type epoxy resin, or a trisphenol methane type epoxy resin; and an aliphatic glycidyl ether compound such as 1,4-butanediol glycidyl ether, glycerol triglycidyl ether, propylene glycol diglycidyl ether, or trimethylol propane triglycidyl ether. As the glycidyl ester, for example, glycidyl ester of linolenic acid dimer or the like can be exemplified.

As the polymerizable compound, a compound having an oxetanyl group which is cyclic ether of a 4-membered ring (hereinafter, simply referred to as an “oxetane compound”) can be used. The oxetanyl group-containing compound is a compound having one or more oxetanyl groups in one molecule.

The content ratio of the binder in the binding solution 12 is preferably 80% or more and more preferably 85% or more. In this manner, it is possible to make the mechanical strength of the three-dimensional structure 10 which is finally obtained particularly excellent.

### Other Components

Further, the binding solution 12 may contain other components other than those described above. Examples of such components include various colorants such as a pigment and a dye; a dispersant; a surfactant; a sensitizer; a polymerization accelerator; a solvent; a permeation promotor; a wetting agent (moisturizing agent); a fixing agent; a fungicide; a preservative; an antioxidant; a UV absorber; a chelating agent; a pH adjusting agent; a thickener; a filler; an aggregation inhibitor; and a defoaming agent.

Particularly, when the binding solution 12 contains a colorant, the three-dimensional structure 10 colored in a color corresponding to the color of the colorant can be obtained.

Particularly, when the colorant includes a pigment, it is possible to make the light resistance of the binding solution 12 and the three-dimensional structure 10 excellent. Any of an inorganic pigment and an organic pigment can be used as a pigment.

Examples of the inorganic pigment include carbon blacks such as furnace black, lamp black, acetylene black, and channel black (C.I. Pigment Black 7); iron oxide; and titanium oxide, and these can be used alone or in combination of two or more kinds thereof.

Among the inorganic pigments, titanium oxide is preferable in order to express a preferred white color.

Examples of the organic pigments include an azo pigment such as an insoluble azo pigment, a condensed azo pigment, azo lake, or a chelate azo pigment; a polycyclic pigment such as a phthalocyanine pigment, a perylene and perinone pigment, an anthraquinone pigment, a quinacridone pigment, a dioxane pigment, a thioindigo pigment, an isoindolinone pigment, or a quinophthalone pigment; dye chelate (for example, basic dye chelate or acidic dye chelate); dye lake (basic dye lake or acidic dye lake); a nitro pigment; a nitroso pigment; aniline black; and daylight fluorescent pigment, and these can be used alone or in combination of two or more kinds thereof.

More specifically, examples of the carbon black used as a black pigment include No. 2300, No. 900, MCF88, No. 33, No. 40, No. 45, No. 52, MA7, MA8, MA100, and No. 2200B (all manufactured by Mitsubishi Chemical Corporation); Raven 5750, Raven 5250, Raven 5000, Raven 3500, Raven 1255, and Raven 700 (all manufactured by Carbon Columbia); Regal 400R, Regal 330R, Regal 660R, Mogul L, Monarch 700, Monarch 800, Monarch 880, Monarch 900, Monarch 1000, Monarch 1100, Monarch 1300, and Monarch 1400 (all manufactured by CABOT JAPAN K.K.); Color Black FW1, Color Black FW2, Color Black FW2V, Color Black FW18, Color Black FW200, Color Black 5150, Color Black 5160, Color Black 5170, Printex 35, Printex U, Printex V, Printex 140U, Special Black 6, Special Black 5, Special Black 4A, and Special Black 4 (all manufactured by Degussa).

Examples of the white pigment include C.I. Pigment White 6, 18, and 21.

Examples of the yellow pigment include C.I. Pigment Yellow 1, 2, 3, 4, 5, 6, 7, 10, 11, 12, 13, 14, 16, 17, 24, 34, 35, 37, 53, 55, 65, 73, 74, 75, 81, 83, 93, 94, 95, 97, 98, 99, 108, 109, 110, 113, 114, 117, 120, 124, 128, 129, 133, 138, 139, 147, 151, 153, 154, 167, 172, and 180.

Examples of the magenta pigment include C.I. Pigment Red 1, 2, 3, 4, 5, 6, 7, 8, 9, 10, 11, 12, 14, 15, 16, 17, 18, 19, 21, 22, 23, 30, 31, 32, 37, 38, 40, 41, 42, 48, (Ca), 48 (Mn), 57 (Ca), 57:1, 88, 112, 114, 122, 123, 144, 146, 149, 150, 166, 168, 170, 171, 175, 176, 177, 178, 179, 184, 185, 187, 202, 209, 219, 224, and 245; and C.I. Pigment Violet Red 19, 23, 32, 33, 36, 38, 43, and 50.

Examples of the cyan pigment include C.I. Pigment Blue 1, 2, 3, 15, 15:1, 15:2, 15:3, 15:34, 15:4, 16, 18, 22, 25, 60, 65, and 66; and C.I. Pigment Bat Blue 4 and 60.

Further, examples of other pigments include C.I. Pigment Green 7 and 10; C.I. Pigment Brown 3, 5, 25, and 26; and C.I. Pigment Orange 1, 2, 5, 7, 13, 14, 15, 16, 24, 34, 36, 38, 40, 43, and 63.

In a case where the binding solution 12 contains a pigment, the average particle diameter of the pigment is preferably 300 nm or less and more preferably 50 nm to 250 nm. In this manner, it is possible to make the ejection stability of the binding solution 12 and the dispersion stability of the pigment in the binding solution 12 particularly excellent and to form an image with more excellent image quality.

Further, examples of the dye include an acid dye, a direct dye, a reactive dye, and a basic dye, and these can be used alone or in combination of two or more kinds thereof.

Specific examples thereof include C.I. Acid Yellow 17, 23, 42, 44, 79, and 142; C.I. Acid Red 52, 80, 82, 249, 254, and 289; C.I. Acid Blue 9, 45, and 249; C.I. Acid Black 1, 2, 24, and 94; C.I. Food Black 1 and 2; C.I. Direct Yellow 1, 12, 24, 33, 50, 55, 58, 86, 132, 142, 144, and 173; C.I. Direct Red 1, 4, 9, 80, 81, 225, and 227; C.I. Direct Blue 1, 2, 15, 71, 86, 87, 98, 165, 199, and 202; C.I. Direct Black 19, 38, 51, 71, 154, 168, 171, and 195; C.I. Reactive Red 14, 32, 55, 79, and 249; and C.I. Reactive Black 3, 4, and 35.

In a case where the binding solution 12 includes a colorant, the content ratio of the colorant in the binding solution 12 is preferably in the range of 1% by mass to 20% by mass. In this manner, particularly excellent hiding properties and color reproducibility can be obtained.

Particularly, in a case where the binding solution 12 contains titanium oxide as a colorant, the content ratio of the titanium oxide in the binding solution 12 for forming an entity portion is preferably in the range of 12% by mass to 18% by mass and more preferably in the range of 14% by mass to 16% by mass. In this manner, particularly excellent hiding properties can be obtained.

In a case where the binding solution 12 contains a pigment, when the ink further contains a dispersant, it is possible to make the dispersibility of the pigment more excellent. As the dispersant, which is not particularly limited, a dispersant normally used for preparing a pigment dispersion liquid of a polymer dispersant or the like can be exemplified. Specific examples of the polymer dispersant include dispersants having one or more kinds, as a main component, among polyoxyalkylene polyalkylene polyamine, a vinyl polymer, a vinyl copolymer, an acrylic polymer, an acrylic copolymer, polyester, polyamide, polyimide, polyurethane, an amino polymer, a silicon-containing polymer, a sulfur-containing polymer, a fluorine-containing polymer, and an epoxy polymer. Examples of a commercially available product of the polymer dispersant include AJISPER series (manufactured by Ajinomoto Fine-Techno Co., Inc.); Solsperse series (Solsperse 36000 or the like) which can be obtained from Noveon; and Disperbyk series (manufactured by BYK-Chemie Co., Ltd.); and DISPARLON series (manufactured by Kusumoto Chemicals, Ltd.).

In a case where the binding solution 12 contains a surfactant, it is possible to make the abrasion resistance of the three-dimensional structure 10 more excellent. As a surfactant, which is not particularly limited, polyester-modified silicone or polyether-modified silicone can be used as a silicone-based surfactant, and polyether-modified polydimethylsiloxane or polyester-modified polydimethylsiloxane is preferably used. Specific examples of the surfactant include BYK-347, BYK-348, BYK-UV3500, 3510, 3530, and 3570 (all manufactured by manufactured by BYK-Chemie Co., Ltd.).

Further, the binding solution 12 may include a solvent. In this manner, it is possible to suitably adjust the viscosity of the binding solution 12 and to make the ejection stability of the binding solution 12 according to an ink jet method particularly excellent even when the binding solution 12 contains components with high viscosity.

Examples of the solvent include (poly)alkylene glycol monoalkyl ethers such as ethylene glycol monomethyl ether, ethylene glycol monoethyl ether, propylene glycol monomethyl ether, and propylene glycol monoethyl ether; acetic acid esters such as ethyl acetate, n-propyl acetate, iso-propyl acetate, n-butyl acetate, and iso-butyl acetate; aromatic hydrocarbons such as benzene, toluene, and xylene; ketones such as methyl ethyl ketone, acetone, methyl isobutyl ketone, ethyl-n-butyl ketone, diisopropyl ketone, and acetyl acetone; and alcohols such as ethanol, propanol, and butanol, and these can be used alone or in combination of two or more kinds thereof.

Further, the viscosity of the binding solution 12 is preferably in the range of 10 mPa·s to 30 mPa·s and more preferably in the range of 15 mPa·s to 25 mPa·s. In this manner, it is possible to make the ejection stability of the binding solution 12 particularly excellent according to an ink jet method. Further, in the present specification, the viscosity is a value measured using an E type viscometer (VISCONIC ELD, manufactured by Tokyo Keiki Co., Ltd.) at 25° C. unless otherwise specified conditions. Further, plural binding solutions 12 may be used for producing the three-dimensional structure 10.

For example, the binding solution 12 (colored ink) containing a colorant and the binding solution 12 (clear ink) not containing colorant may be used. In this manner, for example, the binding solution 12 containing a colorant as the binding solution 12 provided for an area influencing the color tone of the appearance of the three-dimensional structure 10 or the binding solution 12 not containing colorant as the binding solution 12 provided for an area not influencing the color tone of the appearance the three-dimensional structure 10 may be used. Further, in the three-dimensional structure 10 which is finally obtained, plural kinds of binding solutions 12 may be used together such that an area (coat layer) formed using the binding solution 12 not containing colorant is provided on the outermost surface of the area formed using the binding solution 12 containing a colorant.

In addition, for example, plural kinds of binding solutions 12 containing colorants with different compositions from each other may be used. In this manner, a color reproduction area which can be expressed can be widened because of the combination of these binding solutions 12.

When plural kinds of binding solutions 12 are used, it is preferable to use at least an indigo purple (cyan) binding solution 12, a red purple (magenta) binding solution 12, and a yellow binding solution 12. In this manner, a color reproduction area which can be expressed can be more widened because of the combination of these binding solutions 12.

Further, for example, the following effects can be obtained by combining a white binding solution 12 and a binding solution 12 having another color. That is, the three-dimensional structure 10 which is finally obtained may have a first area for which the white binding solution 12 is provided and an area (second area), which is overlapped with the first area and for which the binding solution 12 having a non-white color, is provided on the outer surface side more than the first area. In this manner, the first area for which the white binding solution 12 is provided can exhibit hiding properties and the color saturation of the three-dimensional structure 10 can be further improved.

### Three-Dimensional Structure

The three-dimensional structure of the invention can be produced using the production method and the apparatus for producing a three-dimensional structure described above.

In this manner, it is possible to provide the three-dimensional structure with excellent dimensional precision.

As the usage of the three-dimensional structure of the invention, which is not particularly limited, an object for appreciation or display such as a doll or a figure; and a medical device such as an implant can be exemplified.

Further, the three-dimensional structure of the invention may be applied to any of a prototype, a mass-produced product, or an order-made product.

Hereinbefore, preferred embodiments of the invention have been described, but the invention is not limited thereto.

For example, in the above-described embodiments, a configuration in which the stage is descended along with repeated formation of layers has been described as a typical example, but, in the invention, the relative position of the stage may be directed downward by elevating the film thickness adjusting unit or the like.

In addition, a roller or the like may be used in place of the squeegee described above as the film thickness adjusting unit.

Further, the apparatus for producing a three-dimensional structure of the invention may include a recovery mechanism for recovering the composition removed during the unbonded particle removing process.

In addition, in the above-described embodiments, the description is made that bonding portions are formed on all layers (second layers), but layers on which bonding portions are not formed may be present. For example, a layer formed directly on the stage does not have a bonding portion formed thereon and may function as a sacrificial layer.

Moreover, in the above-described embodiments, a case in which the binding solution is provided according to an ink jet method is mainly described, but the binding solution may be provided using another method (for example, another printing method).

In addition, in the above-described embodiments, a case where all treatments are repeatedly performed by repeatedly performing a series of processes has been described, but the curing treatment performed during the bonding process may not be repeatedly performed. For example, a laminate including plural layers which are not cured is formed and then the treatment may be collectively performed.

Further, in the production method of the invention, a pre-treatment process, an intermediate treatment process, and a post-treatment process may be performed if necessary.

As the pre-treatment process, for example, a cleaning process or the like of the stage can be exemplified.

As the intermediate treatment process, a process of stopping heating (water-soluble resin solidifying process) may be included between the first layer forming process and the bonding process (for example, between the first layer forming process and the film thickness adjusting process) in a case where the composition for three-dimensional forming has a pellet shape. In this manner, since the water-soluble resin enters a solid state, it is possible to obtain a layer with high bonding force among grains. Further, for example, in a case where the composition for three-dimensional forming contains a solvent component (dispersant) such as water, a solvent component removing process removing the solvent component may be included between the first layer forming process and the bonding process (for example, between the first layer forming process and the film thickness adjusting process).

As the post-treatment process, for example, a washing process, a shape adjusting process that performs deburring or the like, a coloring process, a coating layer forming process, or a process of completing curing a binder that performs a light irradiation treatment or a heat treatment for reliably curing an uncured binder can be exemplified.

Further, in the above-described embodiments, a case where the binding solution providing treatment and the curing treatment are performed during the bonding process is mainly described, but the curing treatment does not need to be provided after the binding solution providing treatment in a case where a binder containing a thermoplastic resin is used for the binding solution. Further, in such a case, the apparatus for producing a three-dimensional structure may not include curing unit.

Further, in the above-described embodiments, the description is made that the film thickness adjusting unit moves on the stage, but the positional relationship between the stage and the film thickness adjusting unit may be changed due to the movement of the stage and the second layer may be formed.

Further, in the above-described embodiments, the description is made that the first layer forming unit moves on the stage, but the positional relationship between the stage and the first layer forming unit may be changed due to the movement of the stage.

In addition, in the above-described embodiments, the description is made that the composition is directly provided for the forming area, but, for example, the composition is moved to the forming area and then a layer may be formed (the first layer is formed) after the composition is provided to the temporarily placing portion other than the forming area.

Further, in the above-described embodiments, the description is made that plural processes are concurrently performed, but, for example, each process may be performed in stages. That is, an arbitrary process is performed on a specific layer, the process is completed, and then the next process may be performed.

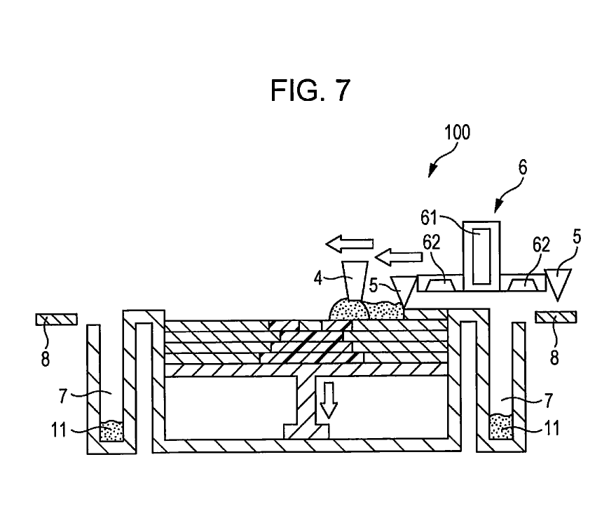

Further, in the above-described embodiments, the description is made that the first layer is formed on the downstream side of the area on which the bonding portion is formed, but the first layer may be formed on the upstream side of the area on which the bonding portion is formed as illustrated in FIG. 7.

The entire disclosure of Japanese Patent Application No. 2014-054507 filed Mar. 18, 2014 is expressly incorporated by reference here in.

What is claimed is:

1. An apparatus for producing a three-dimensional structure that produces a three-dimensional structure by laminating layers using a paste-like composition containing grains, the apparatus comprising:
a stage for which the composition is provided and on which the layers are formed;
a first layer forming unit that supplies the composition to a forming area on the stage and forms a first layer; and
a film thickness adjusting unit that adjusts the film thickness of the first layer and sets the adjusted first layer as a second layer.

2. The apparatus for producing a three-dimensional structure according to claim 1, further comprising a bonding unit that bonds the grains constituting the second layer and forms a bonding portion,
wherein the apparatus is configured such that the film thickness adjusting unit relatively moves with respect to the stage and the bonding unit forms the bonding portion.

3. The apparatus for producing a three-dimensional structure according to claim 2, wherein the film thickness adjusting unit does not relative move with respect to the bonding unit when the film thickness of the first layer is adjusted.

4. The apparatus for producing a three-dimensional structure according to claim 2, wherein the bonding unit includes a binding solution providing unit that provides a binder solution for the second layer.

5. The apparatus for producing a three-dimensional structure according to claim 4,
wherein the binding solution contains a UV curable resin, and
the bonding unit includes a UV irradiation unit in addition to the binding solution providing unit.

6. The apparatus for producing a three-dimensional structure according to claim 5,
wherein the binding solution providing unit relatively moves with respect to the stage and provides the binding solution, and
the UV irradiation unit relatively moves with respect to the stage along with the relative movement of the binding solution providing unit.

7. The apparatus for producing a three-dimensional structure according to claim 4, further comprising a maintenance unit that performs maintenance of the binding solution providing unit.

8. The apparatus for producing a three-dimensional structure according to claim 7, further comprising a recovery unit that recovers the composition removed from the first layer by the film thickness adjusting unit,
wherein the maintenance unit performs maintenance of the binding solution when the recovery unit recovers the composition.

9. The apparatus for producing a three-dimensional structure according to claim 2, wherein the bonding unit and the stage are capable of performing height adjustment thereof independently from each other.

10. The apparatus for producing a three-dimensional structure according to claim 1, wherein the film thickness adjusting unit and the stage are capable of performing height adjustment thereof independently from each other.

11. The apparatus for producing a three-dimensional structure according to claim 1, wherein the film thickness adjusting unit adjusts the film thickness of the second layer to be smaller than the film thickness of the first layer.

12. The apparatus for producing a three-dimensional structure according to claim 1, further comprising a recovery unit that recovers the composition removed from the first layer by the film thickness adjusting unit.

13. The apparatus for producing a three-dimensional structure according to claim 1, wherein the first layer forming unit is a dispenser that directly supplies the composition to the forming area.

14. The apparatus for producing a three-dimensional structure according to claim 1, wherein the apparatus is configured such that the composition is supplied to the forming area by the first layer forming unit and then the film thickness of the area is adjusted by the film thickness adjusting unit after 10 milliseconds to 10 seconds have passed.

15. The apparatus for producing a three-dimensional structure according to claim 1, wherein the first layer forming unit is configured so as to be movable independently from the film thickness adjusting unit.

16. The apparatus for producing a three-dimensional structure according to claim 1, wherein at least one of the first layer forming unit and the film thickness adjusting unit includes a vibration providing unit that provides vibration.

17. A method of producing a three-dimensional structure which produces a three-dimensional structure using the apparatus for producing a three-dimensional structure according to claim 1.

18. A method of producing a three-dimensional structure, comprising:
forming a first layer by supplying a paste-like composition containing grains to a forming area on a stage; and
adjusting the film thickness of the first layer by a film thickness adjusting unit and setting the adjusted first layer as a second layer.

19. The method of producing a three-dimensional structure according to claim 18, further comprising bonding the grains constituting the second layer and forming a bonding portion,
wherein a plurality of layers are laminated with one another by repeatedly performing a series of the adjusting of the film thickness and the bonding of the grains, and
the adjusting of the film thickness and the bonding of the grains are performed in an interlocked manner by relatively moving the film thickness adjusting unit with respect to the stage and forming the boning unit using the bonding unit.

20. The method of producing a three-dimensional structure according to claim 18, wherein the adjusting of the film thickness is performed by adjusting the film thickness of the second layer to be smaller than the film thickness of the first layer.

21. The method of producing a three-dimensional structure according to claim 18, wherein providing of a binding solution containing a UV curable resin for the second layer and curing of the UV curable resin are performed in the bonding of the grains.

22. A three-dimensional structure which is produced using the apparatus for producing a three-dimensional structure according to claim 1.
